(19) United States
(12) Patent Application Publication
(10) Pub. No.: US 2003/0163374 A1
(43) Pub. Date: Aug. 28, 2003

(54) Point service providing system with mechanism for preventing illegal use of point data

(75) Inventor: Koichiro Akiyama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/375,348

(22) Filed: Feb. 28, 2003

(30) Foreign Application Priority Data
Feb. 28, 2002 (JP) 2002-053759

(51) Int. Cl. G06F 17/60

(52) U.S. Cl. 705/14

(57) ABSTRACT

A point generation device generates a granted point data having a granted point data body which contains information on a number of points granted to a portable terminal, and a granted point authentication data, and authenticates a consuming point data having a consuming point data body which contains information on a number of points to be consumed by the portable terminal, and a consuming point authentication data. The portable terminal authenticates the granted point data, and generate the consuming point data.

### BACKGROUND OF THE INVENTION

1. Field of the Invention

The present invention relates to a point generation device, a portable terminal, a point management server and a point management system for generating and consuming point data of the point service.

2. Description of the Related Art

The point service is widely utilized by stores in order to increase regular customers, and well established as a service form to provide discounts to the customers. In the ordinary point service, the store issues a magnetic card to the customer in advance, and requests the customer to present that magnetic card at the cashier. This magnetic card records a customer ID, and the accounting device such as POS system reads this ID data, searches through a database on a point server provided in the store by using that ID data, and grants or consumes the points by adding or subtracting points according to the searched point data.

In the chain store that utilize the point service of this type, the points of the customers are collectively managed by the database on the point server located at the headquarters. The point server of each store updates data at a frequency of once a day or so. For this reason, there can be cases where the point transactions are made at different affiliated stores on the same day, the points added or subtracted by the earlier transaction are not reflected at a time of the later transaction. This problem can be resolved if the point server of the store is permanently connected to the main point server, but this solution is unrealistic as it requires a huge communication cost.

Also, in order to carry out the service in the form described above, there is a need to provide at least a server device for managing points, a POS terminal for producing a point card and reading the point card, and a software for realizing the point service. For this reason, the very large initial investment is required, which makes it difficult for the small scale chain stores or the general retail stores to introduce this service.

On the other hand, there exists a service that does not utilize the magnetic card, in which marks are stamped on a paper medium according to the purchased amount, and the discount is provided according to the number of stamped marks. This form of the point service does not require much initial investment, and the granted or consumed points can be reflected at a spot, so that it is widely utilized by the small scale chain stores and the general retail stores.

However, in this type of service, the stores practically cannot manage the points of the customers, and there is a high probability of the illegal act such as forging the stamps, so that it is not suitable for the point service that offers high price point returns.

In either form of the point service, the magnetic card or the stamp card must be issued by each store (or each chain store group), so that the today's customer holds numerous cards, which are difficult to manage, and often encounters a situation where the necessary card is not at hand at the necessary time.

On the other hand, the portable terminals such as portable telephones and electronic pocketbooks are becoming widespread. These portable terminals are equipped with both a communication function and a calculation function, and the communication function that includes not just a telephone function but also the Internet access service utilizing the telephone channel is becoming popular.

Also, in recent years, the portable terminals equipped with a short range radio communication function such as Bluetooth or IrDA are commercially available. By utilizing these radio functions, it is possible to realize the charge free communications although they are limited to the short range communications. In addition, the calculation function is also provided so that it is possible to realize the generation and the verification of the digital signature at a time of carrying out communications.

### BRIEF SUMMARY OF THE INVENTION

It is therefore an object of the present invention to provide a point management system using a point generation device, a portable terminal and a point management server, which is capable of ensuring the prevention of the illegal use of the point data, while enabling the granting or consuming of the point data that is both easy and quick.

According to one aspect of the present invention there is provided a point generation device for carrying out generation and authentication of point data for a portable terminal, the point generation device comprising: a granted point data generation unit configured to generate a granted point data having a granted point data body which contains information on a number of points granted to the portable terminal, and a granted point authentication data to be used in authenticating the granted point data body; a consuming point data authentication unit configured to carry out authentication of a consuming point data having a consuming point data body which contains information on a number of points to be consumed by the portable terminal, and a consuming point authentication data to be used in authenticating the consuming point data body; and a point data transmission unit configured to transmit the granted point data to the portable terminal and a point management server for managing point data, and transmit the consuming point data to the point management server.

According to another aspect of the present invention there is provided a point generation device for carrying out generation and authentication of point data for a portable terminal, the point generation device comprising: a total point data authentication unit configured to carry out authentication of a total point data having a total point data body which contains a total number of points of the portable terminal and a date information for identifying point granted dates, and a total point authentication data to be used in authenticating the total point data body; an updated point data generation unit configured to generate an updated point data having an updated point data body which contains information on the total number of points of the portable terminal as updated according to transaction contents at a point issuing organization and updated date information, and an updated point authentication data to be used in authenticating the updated point data body; and an updated point transmission unit configured to transmit the updated point data to a point management server.

According to another aspect of the present invention there is provided a portable terminal for carrying out authentication and consumption of point data generated by a point generation device, the portable terminal comprising: a granted point data authentication unit configured to carry out authentication of a granted point data having a granted point data body which contains information on a number of points granted from the point generation device, and a granted point authentication data to be used in authenticating the granted point data body; and a consuming point data generation unit configured to generate a consuming point data having a consuming point data body which contains information on a number of points to be consumed by the portable terminal, and a consuming point authentication data to be used in authenticating the consuming point data body.

According to another aspect of the present invention there is provided a portable terminal for carrying out authentication and consumption of point data generated by the point generation device, the portable terminal comprising: a total point data storage unit configured to store a total point data having a total point data body which contains a total number of points of the portable terminal and a date information for identifying point granted dates, and a total point authentication data to be used in authenticating the total point data body; and a data transmission control unit configured to transmit at least a part of the total point data stored in the total point data storage unit for a purpose of point transaction, and to store an updated point data having an updated point data body which contains information on an updated total number of points of the portable terminal and updated date information, and an updated point authentication data to be used in authenticating the updated point data body, into the total point data storage unit.

According to another aspect of the present invention there is provided a point management system, comprising: a point generation device for carrying out generation and authentication of point data; a portable terminal for carrying out authentication and consumption of the point data generated by the point generation device; and a point management server for carrying out management of the point data; wherein the point generation device has: a granted point data generation unit configured to generate a granted point data having a granted point data body which contains information on a number of points granted to the portable terminal, and a granted point authentication data to be used in authenticating the granted point data body; a consuming point data authentication unit configured to carry out authentication of a consuming point data having a consuming point data body which contains information on a number of points to be consumed by the portable terminal, and a consuming point authentication data to be used in authenticating the consuming point data body; and a point data transmission unit configured to transmit the granted point data to the portable terminal and the point management server, and transmit the consuming point data to the point management server; and the portable terminal has: a granted point data authentication unit configured to carry out authentication of the granted point data having the granted point data body which contains information on a number of points granted from the point generation device, and the granted point authentication data to be used in authenticating the granted point data body; and a consuming point data generation unit configured to generate the consuming point data having the consuming point data body which contains information on a number of points to be consumed by the portable terminal, and the consuming point authentication data to be used in authenticating the consuming point data body.

According to another aspect of the present invention there is provided a point management system, comprising: a point generation device for carrying out generation and authentication of point data; a portable terminal for carrying out authentication and consumption of the point data generated by the point generation device; and a point management server for carrying out management of the point data; wherein the point generation device has: a total point data authentication unit configured to carry out authentication of a total point data having a total point data body which contains a total number of points of the portable terminal and a date information for identifying point granted dates, and a total point authentication data to be used in authenticating the total point data body; an updated point data generation unit configured to generate an updated point data having an updated point data body which contains information on the total number of points of the portable terminal as updated according to transaction contents at a point issuing organization and updated date information, and an updated point authentication data to be used in authenticating the updated point data body; and an updated point transmission unit configured to transmit the updated point data to a point management server; and the portable terminal has: a total point data storage unit configured to store the total point data having the total point data body which contains a total number of points of the portable terminal and the date information for identifying point granted dates, and the total point authentication data to be used in authenticating the total point data body; and a data transmission control unit configured to transmit at least a part of the total point data stored in the total point data storage unit for a purpose of point transaction, and to store the updated point data having the updated point data body which contains information on an updated total number of points of the portable terminal and the updated date information, and the updated point authentication data to be used in authenticating the updated point data body, into the total point data storage unit.

Other features and advantages of the present invention will become apparent from the following description taken in conjunction with the accompanying drawings.

### BRIEF DESCRIPTION OF THE DRAWINGS

FIG. 1 is a block diagram showing a schematic configuration of a point management system according to the first embodiment of the present invention.

FIG. 2 is a block diagram showing a schematic configuration of a point generation device according to the first embodiment of the present invention.

FIG. 3 is a block diagram showing a schematic configuration of a portable terminal according to the first embodiment of the present invention.

FIG. 4 is a block diagram showing a schematic configuration of a main point server according to the first embodiment of the present invention.

FIG. 5 is a diagram showing a data structure of a granted point data used in the first embodiment of the present invention.

FIG. 6 is a diagram showing a data structure of a consuming point data used in the first embodiment of the present invention.

FIG. 7 is a diagram showing a data structure of a public key certificate of a point generation device used in the first embodiment of the present invention.

FIG. 8 is a diagram showing a data structure of a public key certificate of a portable terminal used in the first embodiment of the present invention.

FIG. 9 is a diagram showing a data structure of a public key certificate of a device used in the first embodiment of the present invention.

FIG. 10 is a flow chart showing an exemplary point granting algorithm used in the point management system of FIG. 1.

FIG. 11 is a flow chart showing an exemplary point consuming algorithm used in the point management system of FIG. 1.

FIG. 12 is a flow chart showing an exemplary algorithm for a point granting processing to be carried out by the point generation device of FIG. 2.

FIG. 13 is a flow chart showing an exemplary authentication algorithm used in the point management system of FIG. 1.

FIG. 14 is a flow chart showing an exemplary algorithm for a device authentication to be carried out by the point generation device of FIG. 2.

FIG. 15 is a flow chart showing an exemplary algorithm for a point consuming processing to be carried out by the point generation device of FIG. 2.

FIG. 16 is a flow chart showing an exemplary granted point processing to be carried out by the portable terminal of FIG. 3.

FIG. 17 is a flow chart showing an exemplary consuming point processing to be carried out by the portable terminal of FIG. 3.

FIG. 18 is a flow chart showing an exemplary point data checking processing to be carried out by the main point server of FIG. 4.

FIG. 19 is a diagram showing a data structure of a point data used in the second embodiment of the present invention.

FIG. 20 is a block diagram showing a schematic configuration of a point generation device according to the second embodiment of the present invention.

FIG. 21 is a block diagram showing a schematic configuration of a portable terminal according to the second embodiment of the present invention.

FIG. 22 is a flow chart showing a first part of an exemplary point data processing to be carried out by the point generation device of FIG. 20.

FIG. 23 is a flow chart showing a second part of an exemplary point data processing to be carried out by the point generation device of FIG. 20.

FIG. 24 is a flow chart showing an exemplary point data processing to be carried out by the portable terminal of FIG. 21.

FIG. 25 is a flow chart showing an exemplary point data checking processing to be carried out by the main point server according to the second embodiment of the present invention.

### DETAILED DESCRIPTION OF THE INVENTION

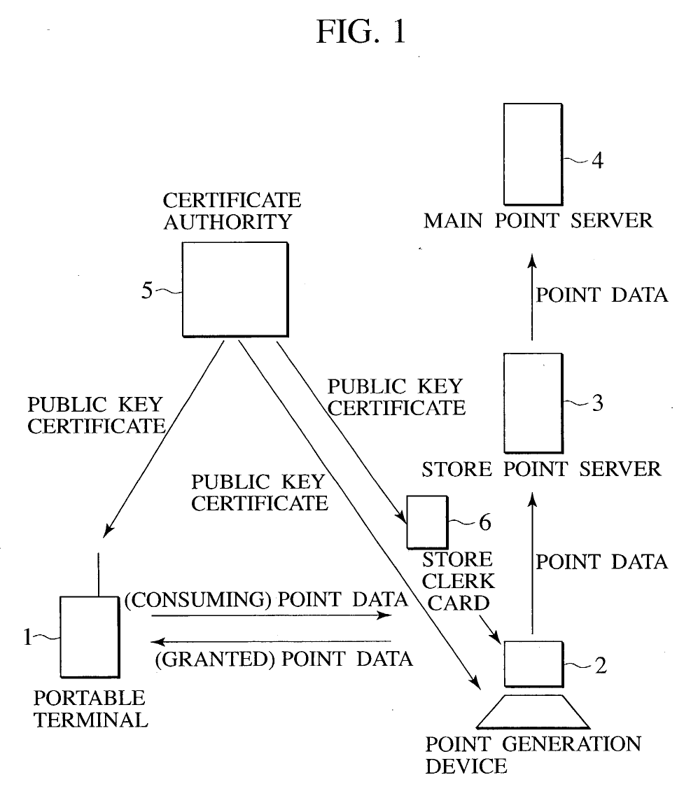

Referring now to FIG. 1 to FIG. 18, the first embodiment of a point management system according to the present invention will be described in detail.

FIG. 1 shows a schematic configuration of the point management system according to the first embodiment of the present invention. The point management system of FIG. 1 comprises a portable terminal 1 which stores the point data according to the record of utilization, a point generation device 2 for generating the point data for each individual portable terminal 1, a store point server 3 for collecting the point data of each store, a main point server 4 for collectively managing the point data managed by all the store point servers 3, and a certificate authority 5 for issuing public key certificates.

The certificate authority 5 issues in advance a public key certificate for each portable terminal 1 and a public key certificate for each point generation device 2. Also, the certificate authority 5 issues a public key certificate of each portable terminal 1 for each user, and a public key certificate of each store for each store clerk.

The issued public key certificate for the portable terminal 1 is transmitted in advance to the portable terminal 1, and the issued public key certificate for the point generation device 2 is transmitted in advance to the point generation device 2. The public key certificate for the store clerk is recorded in advance in a store clerk card 6.

The certificate authority of this system only plays a role of confirming the identity of a person or a device and producing the above described public key certificate.

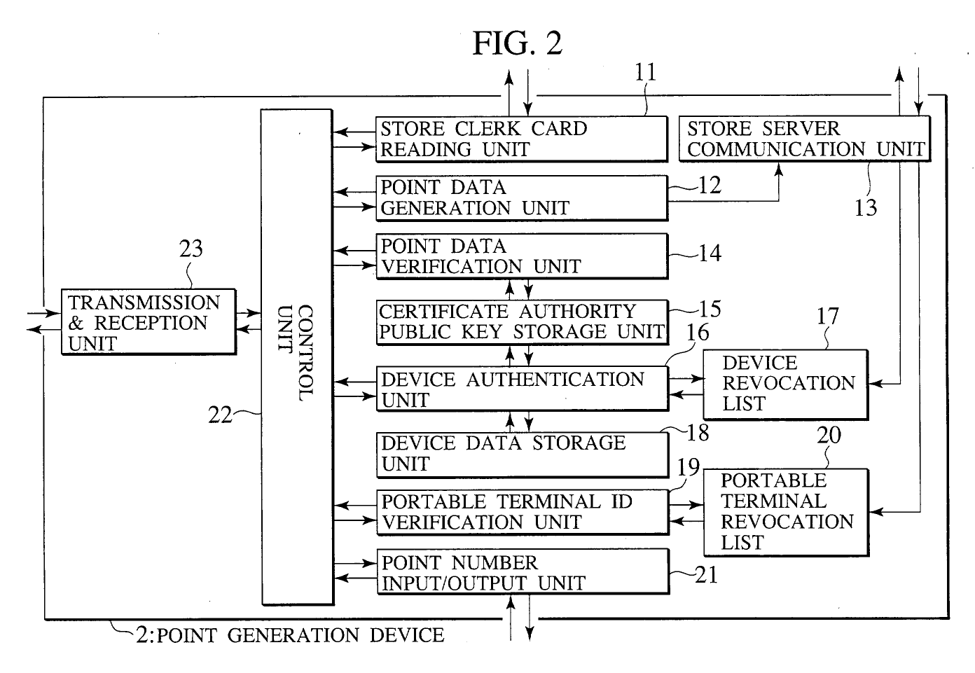

FIG. 2 shows a schematic configuration of the point generation device 2 according to the first embodiment of the present invention.

The point generation device 2 of FIG. 2 comprises a store clerk card reading unit 11 for reading information on a store clerk, a point data generation unit 12 for generating the point data of the portable terminal 1, a store server communication unit 13 for carrying out transmission/reception with the store point server 3, a point data verification unit 14 for verifying the point data, a certificate authority public key storage unit 15 for storing the public key that is authenticated by the certificate authority 5, a device authentication unit 16 for authenticating the portable terminal 1 of each model number, a device revocation list 17 for registering a list of illegal model numbers of the portable terminals 1, a device data storage unit 18 for storing data regarding model numbers of the portable terminals 1, a portable terminal ID verification unit 19 for verifying whether the ID of the individual portable terminal 1 is illegal or not, a portable terminal revocation list 20 for registering a list of illegal portable terminals 1, a point number input/output unit 21 for inputting/outputting the point number, a control unit 22 for controlling the entire device, and the transmission and reception unit 23 for carrying out radio communications with the portable terminal 1.

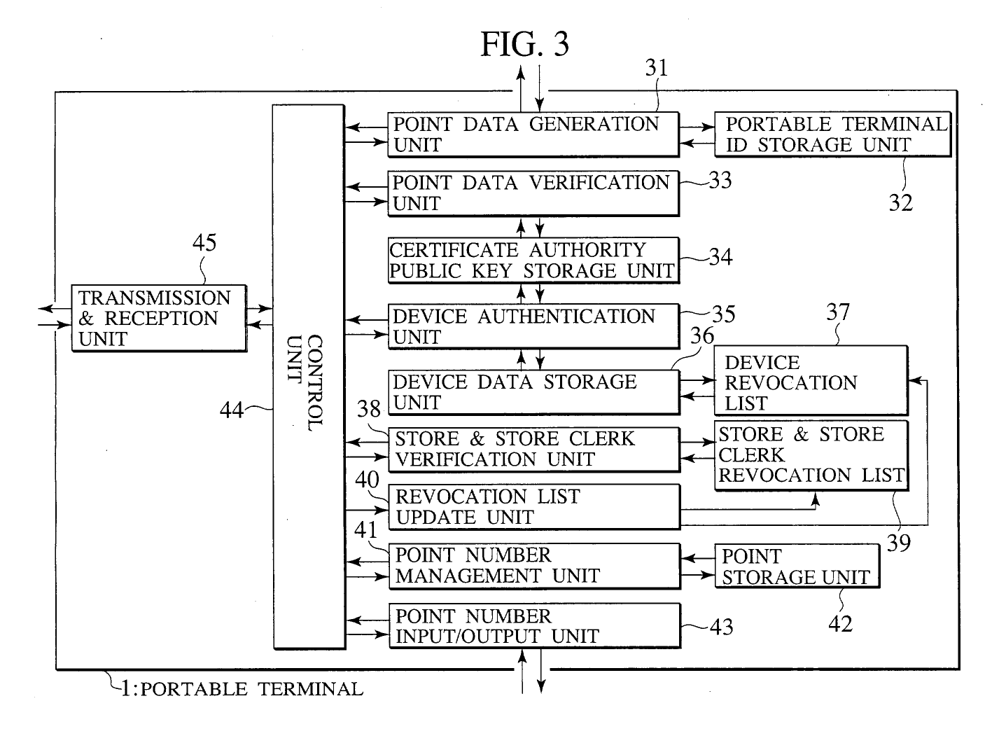

FIG. 3 shows a schematic configuration of the portable terminal 1 according to the first embodiment of the present invention.

The portable terminal 1 of FIG. 3 comprises a point data generation unit 31 for generating the point data regarding the number of consumed points, a portable terminal ID storage unit 32 for storing the ID for identifying the individual portable terminal 1, a point data verification unit 33, a certificate authority public key storage unit 34 for storing the public key of the portable terminal 1 that is authenticated by the certificate authority 5, a device authentication unit 35 for authenticating the point generation device 2 of each model number, a device data storage unit 36 for storing data regarding the model numbers of the point generation devices 2, a device revocation list 37 for registering a list of illegal model numbers of the point generation devices 2, a store and store clerk verification unit 38 for verifying whether at least one of the store and the store clerk is illegal or not, a store and store clerk revocation list 39 for registering a list of illegal store and store clerks, a revocation list update unit 40 for updating the revocation lists, a point number management unit 41 for managing the point number of the portable terminal 1, a point data storage unit 42 for storing the point data, a point number input/output unit 43, a control unit 44 for controlling the entire device, and the transmission and reception unit 45 for carrying out radio communications with the point generation device 2.

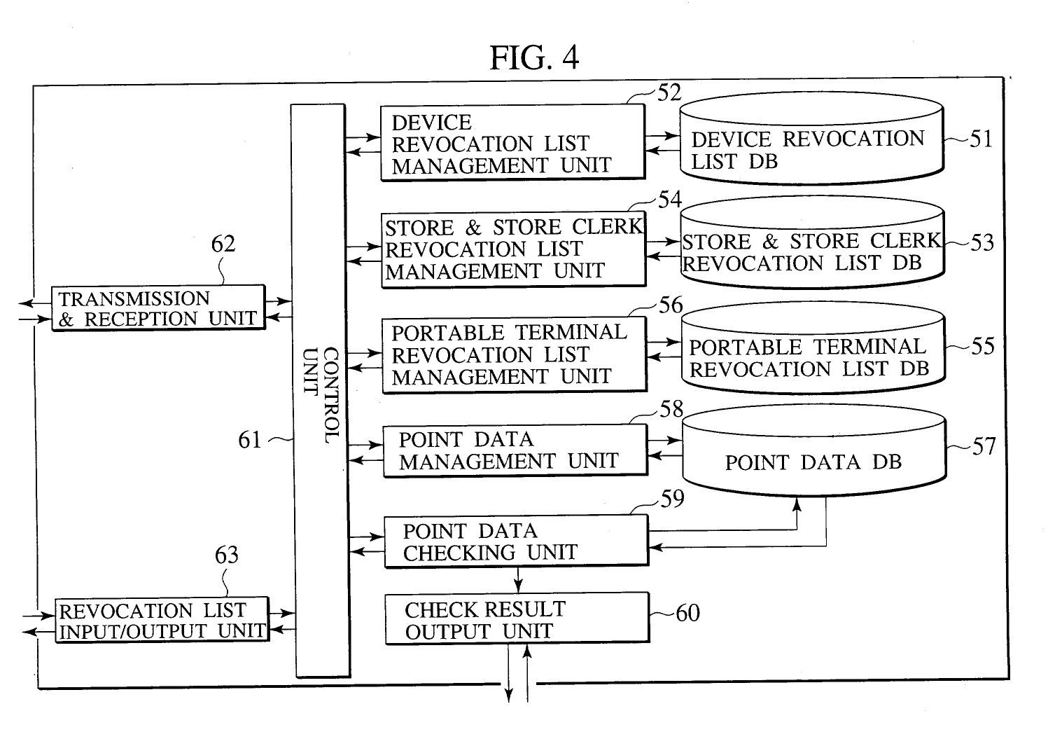

FIG. 4 shows a schematic configuration of the main pointer server 4 according to the first embodiment of the present invention.

The main point server 4 of FIG. 4 comprises a device revocation list DB (database) 51 for registering the illegal model numbers of the portable terminals 1 and the point generation devices 2, a device revocation list management unit 52 for managing the device revocation list DB 51, a store and store clerk revocation list DB (database) 53 for registering the illegal stores and store clerks, a store and store clerk revocation list management unit 54 for managing the store and store clerk revocation list DB 53, a portable terminal revocation list DB (database) 55 for registering the illegal portable terminals 1, a portable terminal revocation list management unit 56 for managing the portable terminal revocation list DB 55, a point data DB (database) 57 for registering the point data for each portable terminal 1, a point data management unit 58 for managing the point data DB 57, a point data checking unit 59 for checking whether the point data is illegal or not, a check result output unit 60, a control unit 61 for controlling the entire device, a transmission and reception unit 62 for carrying out data communications with the store point servers 3, and a revocation list input/output unit 63.

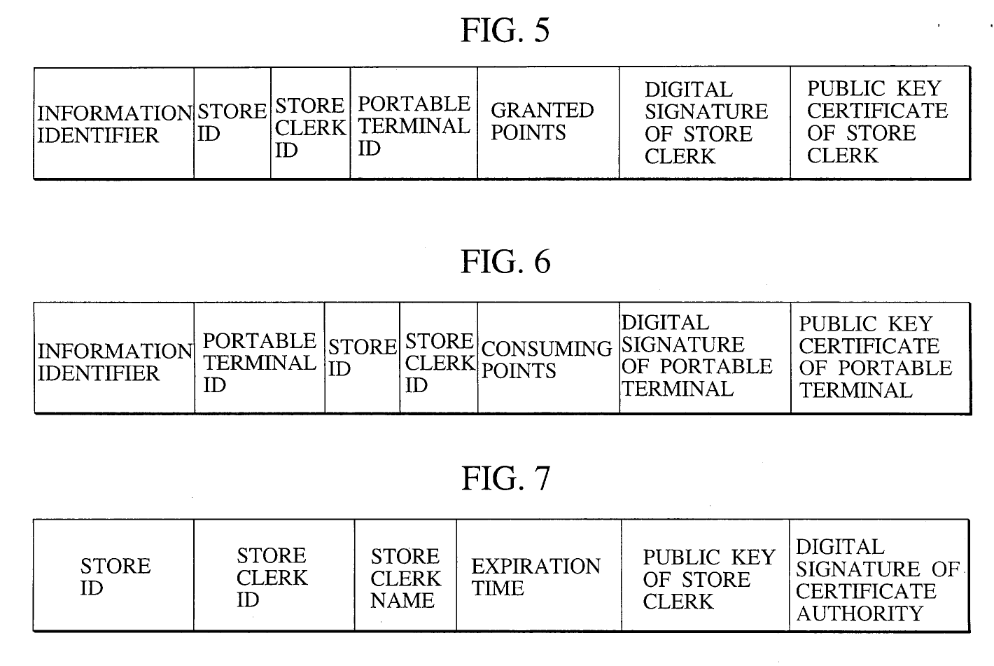

The point data handled by this embodiment have type types, including a granted point data for granting points to the portable terminal 1 which is to be generated by the point generation device 2, and a consuming point data to be used by the portable terminal 1. The granted point data has a data structure as shown in FIG. 5, which includes an information identifier, a store ID, a store clerk ID, a portable terminal ID, granted points, a digital signature of a store clerk, and a public key certificate of the store clerk. The consuming point data has a data structure as shown in FIG. 6, which includes an information identifier, a portable terminal ID, a store ID, a store clerk ID, consuming points, a digital signature of the portable terminal 1, and a public key certificate of the portable terminal 1.

In FIG. 5 and FIG. 6, the information identifier is an identifier indicating that this information is the granted point data or the consuming point data. The store ID is an ID of the store that sells or provides various products or services, and the store clerk ID is an ID of the store clerk of the store corresponding to the store ID. Namely, the store clerk can be uniquely identified by a combination of the store ID and the store clerk ID, so that it is possible to identify this store clerk as one who issued the granted points. The portable terminal ID is an ID of the portable terminal 1 to which the points are granted. The granted points indicates the number of points granted, and the digital signature of the store clerk is a digital signature produced by the store clerk of the store clerk ID with respect to the data from the information identifier up to the granted points.

In this specification, a portion (from the information identifier up to the granted points) that is a target of the digital signature will be referred to as the granted point data body or the consuming point data body, and the digital signature and the public key certificate will be referred to as the granted point authentication data of the consuming point authentication data. Here, the public key certificate of the store clerk is a certificate certified by the certificate authority 5, which certifies that the public key of the store clerk with the store clerk ID is genuine, and the public key certificate of the portable terminal 1 is a certificate certified by the certificate authority 5, which certifies that the public key of the portable terminal with the portable terminal ID is genuine.

Here, the digital signature will be described briefly. The digital signature in this embodiment is realized by the scheme using the public key cryptosystem, in which what is signed by using the secret key Ks is verified by using the public key. In the public key cryptosystem, it is extremely difficult to derive the secret key from the public key, so that it is practically impossible to produce the digital signature by the third person, as long as the secret key is not leaked even though the public key is disclosed in public. In addition, the public key can be literally disclosed in public, so that the signature verification can be done even with a customer who visited the store for the first time, and therefore it is most suitable for the system dealing with the unspecified many such as the point service system. The currently available public key cryptosystem includes the RSA cryptosystem and the elliptic curve cryptosystem, which are still developed for the improvement.

However, such a very convenient public key cryptosystem is not without problems. Namely, in order to realize the public key cryptosystem, there is a need to generate a pair of the public key and the secret key, and this generation itself does not require much time and can be realized easily by anyone if the software is available. Consequently, when the granted point data with the digital signature and the public key for verification are received from the correspondent, whether this public key is the public key of the store clerk indicated by the store ID or not cannot be ascertained immediately.

In other words, when someone who is pretending this store clerk generates a pair of the public key and the secret key attaches the signature to the point data by using the generated secret key, and transmits the generated public key as that of this store clerk by deception, the authenticity of the digital signature of the point data can be checked by the received public key, so that the point generation device 2 that received the point data will erroneously regard this point data as one that is issued by the store clerk who actually has that store ID. In order to prevent such an illegal act, there is a need to have a third party to certify that the received public key is definitely that of this store clerk. This is done by the public key certificate.

FIG. 7 shows a data structure of the public key certificate of the store clerk. The public key certificate of the store clerk contains a store ID, a store clerk ID, a name of this store clerk, an expiration time of this public key certificate, a public key of this store clerk, and a digital signature of the certificate authority 5.

Here, the digital signature of the certificate authority will be described briefly. The certificate authority 5 is an entity that can be a third party to any one of the store clerks and the customers, which is an organization for certifying the public key and its owner. When the production of the public key certificate is requested from the store clerk, the certificate authority 5 checks that the requestor is definitely this store clerk by using the driver's license or the other proof, produces the signature by using the secret key of the certificate authority 5 for a portion from the store ID up to the public key of the store clerk in FIG. 7, and includes it in the above described granted point authentication data or consuming point authentication data. On the other hand, the public key of the certificate authority 5 is designed to be possessed commonly by all the portable terminals 1 and all the point generation devices 2. In this way, the portable terminal 1 and the point generation device 2 can check the authenticity of the received public key.

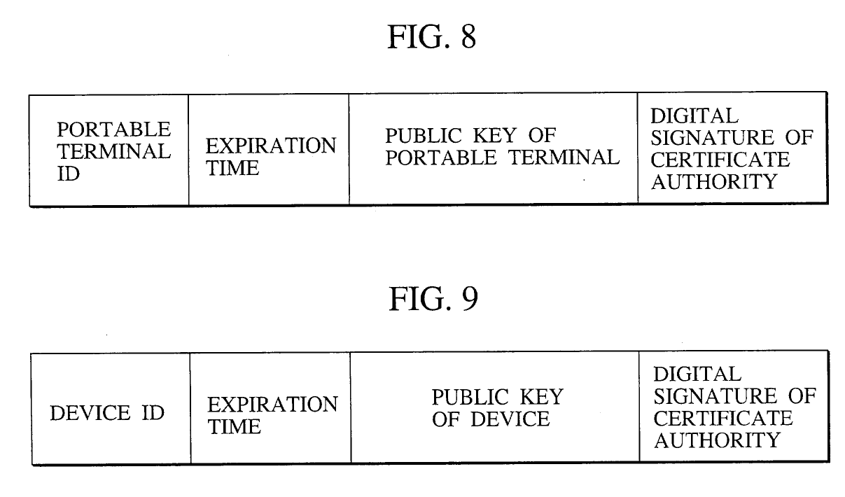

FIG. 8 shows a data structure of the public key certificate of the portable terminal 1. The public key certificate of the portable terminal 1 contains a portable terminal ID, an expiration time of this public key certificate, a public key of the portable terminal 1, and a digital signature of the certificate authority 5. The role of each element is the same as in the public key certificate of the store clerk so that its description is omitted here.

FIG. 9 shows a data structure of the public key certificate of the device. The public key certificate of the device becomes necessary in the device authentication processing to be described below, which is a certificate necessary in checking whether this device is a trustworthy device or not in terms of the security, etc., which is basically given to each device type such as the portable terminal 1 or the point generation device 2. Namely, the device types of the same model number have the same device ID, and the same certificate is issued. More specifically, the public key certificate of the device contains a device ID, an expiration time of this public key certificate, a public key of the device, and a digital signature of the certificate authority 5. The role of each element is the same as the public key certificate of the store clerk so that its description will be omitted here.

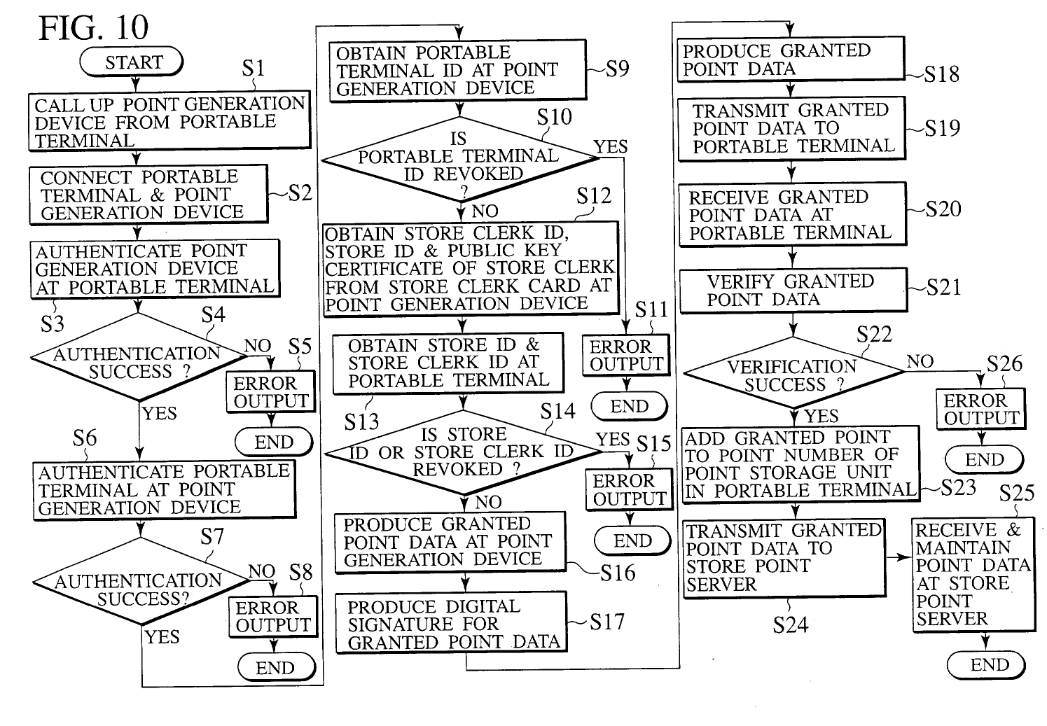

Next, the point granting algorithm will be described with reference to FIG. 10. First, when the customer makes a purchase and a right for points is created, the communication is carried out between the portable terminal 1 owned by the customer and the point generation device 2 (steps S1, S2). By this communication, each one of the portable terminal 1 of the customer and the point generation device 2 authenticates the other as an authentic device in compliance with the security standard, by using the protocol to be described below (steps S3, S4, S6, S7). When the authentication fails, this portable terminal 1 or this point generation device 2 may possibly be not in compliance with the necessary security standard, so that the processing is interrupted at this point (steps S5, S8).

When the authentication succeeds, next, the point generation device 2 acquires the portable terminal ID from the.portable terminal 1 (step S9), and checks whether this portable terminal 1 is revoked or not by searching through the portable terminal revocation list 20 possessed by the point generation device 2 (step S10). Here, if it is revoked, the processing is finished immediately (step S11). If it is not revoked, in order to enable the portable terminal 1 to check whether the store clerk is a trustworthy person or not, the point generation device 2 acquires the store ID, the store clerk ID and the public key certificate of this store clerk from the store clerk card 6 (step S12), and transmits the store ID and the store clerk ID to the portable terminal 1.

Upon receiving them (step S13), the portable terminal 1 checks whether this store ID or this store clerk ID is revoked or not by searching through the store and store clerk revocation list 39 possessed by the portable terminal 1 (step S14). If it is revoked, the processing is finished immediately (step S15).

If it is not revoked, the point generation device 2 generates the granted point data body and the digital signature with respect to it, by utilizing the earlier acquired granted points, the store ID, the store clerk ID, and the portable terminal ID (steps S16, S17), to produce the granted point data (step S18). The generated granted point data are transmitted to the portable terminal 1 (step S19). The portable terminal 1 receives this (step S20), authenticates the public key certificate attached to that data, acquires the public key of the store clerk and verifies the digital signature of the store clerk contained in that data (step S21).

If the verification succeeds, this granted point data can be regarded as not altered, so that the points are updated by adding the granted points contained in that data to the points recorded inside the portable terminal 1 (steps S22, S23). In addition, the point generation device 2 transmits the granted point data to the store point server 3 (step S24), and the store point server 3 receives it and stores it (step S25). Note that if the verification of the granted point data fails, the possibility of the alteration cannot be denied, so that the granted points inside the portable terminal 1 are not updated, and an error output is made and the processing is finished (step S26).

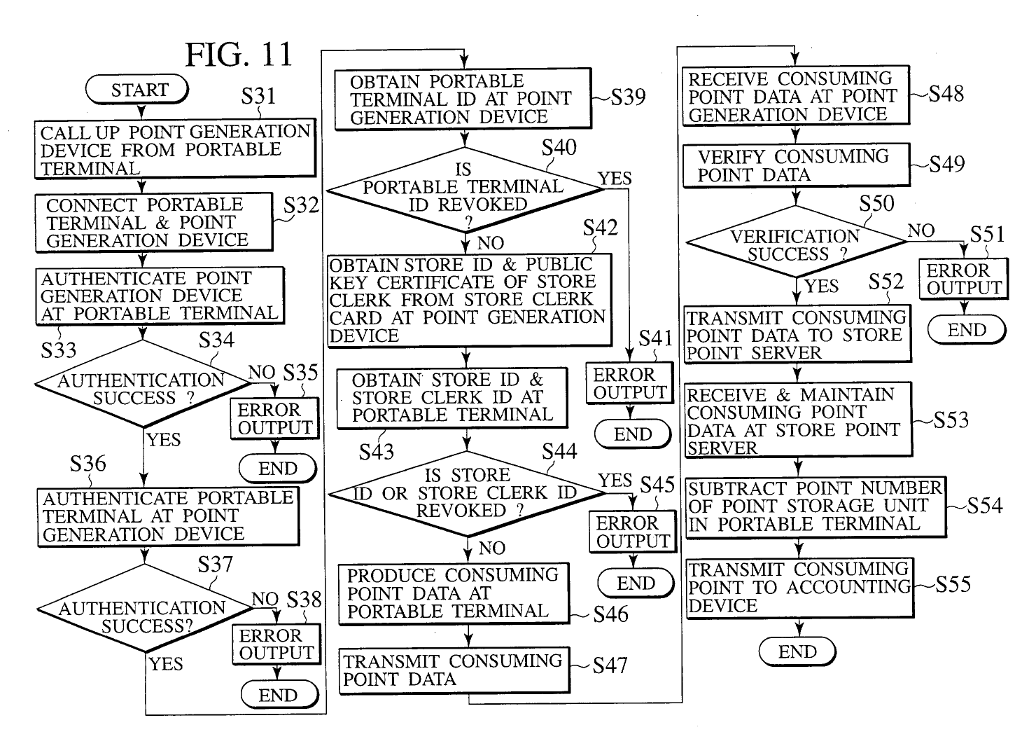

Next, the point consuming algorithm will be described with reference to FIG. 11. When the customer purchases a product or receives a provided service, if the customer wishes to request the discount by consuming the points, the point generation device 2 is called up by the communication from the portable terminal 1 of this customer to make a connection (step S31, S32), and each one checks the other as an authentic device according to the security standard by carrying out the mutual authentication similarly as described above (steps S33 to S38). If the mutual authentication fails, the processing is interrupted at that point (steps S35, S38).

If the mutual authentication succeeds, similarly as in the algorithm described above, the point generation device 2 acquires the portable terminal ID from the portable terminal 1 (step S39), and checks whether this portable terminal 1 is revoked or not by searching through the portable terminal revocation list 20 possessed by the point generation device 2. Here if it is revoked the processing is finished immediately (steps S40, S41). If it is not revoked, in order to enable the portable terminal 1 to check whether the store clerk is a trustworthy person or not, the point generation device 2 acquires the store ID, the store clerk ID and the public key certificate of this store clerk from the store clerk card 6, and transmits the store ID and the store clerk ID to the portable terminal 1 (step S42).

Upon receiving them, the portable terminal 1 checks whether this store ID or this store clerk ID is revoked or not by searching through the store and store clerk revocation list 39 possessed by the portable terminal 1. If it is revoked, the processing is finished immediately (steps S43 to S45).

If it is not revoked, the portable terminal 1 generates the consuming point data body and the digital signature with respect to it, by utilizing the earlier acquired points, the store ID, the store clerk ID, and the portable terminal ID, to produce the consuming point data (step S46). The generated consuming point data are transmitted to the point generation device 2 (step S47). The point generation device 2 receives this (step S48), authenticates the public key certificate attached to that data, acquires the public key of the portable terminal 1 and verifies the digital signature contained in that data (steps S49, S50).

If the verification of the consuming point data fails, the possibility of the alteration cannot be denied, so that the use of the points is not allowed, and an error output is made and the processing is finished (step S51). If the verification succeeds, this consuming point data can be regarded as not altered, so that this consuming point data is transmitted to the store point server 3 (step S52), and the store point server 3 manages it and transmits it at a rate of about once a day (step S53).

The portable terminal 1 subtracts the points recorded inside the portable terminal 1 according to the consuming points (step S54). The point generation device 2 outputs the consuming point data to the store point server 3, and then outputs the point data to an accounting device (not shown) which is provided separately from the point generation device 2, in order to discount according to the consuming point number (step S55). The accounting device has a register function for calculating the charged amount, and subtracts the purchased amount of the customer or the service proding fee by counting one point as one yen, for example, according to the point data from the point generation device 2.

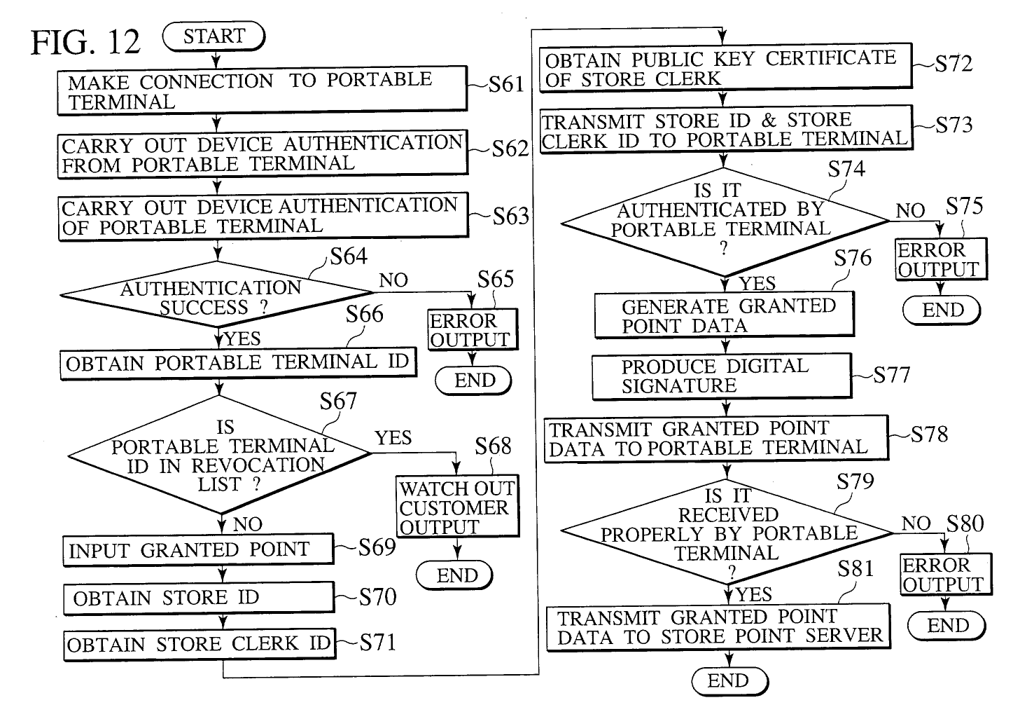

Next, the point granting processing to be carried out by the point generation device 2 will be described with reference to FIG. 12.

At a time of granting the points, first the point generation device 2 is called up by a communication from the portable terminal 1 (step S61). The communication that is assumed to be used here is the short range radio communication such as Bluetooth and IrDA, rather than the communication via a telephone station. This type of short range radio communication does not incur any telephone cost, and has merits such as the high speed communication, so that it can be utilized easily for the point service. However, the following system is equally applicable to the communication of the public channel type via a telephone station.

When the point generation device 2 responds in response to the call up from the portable terminal 1, a connection is made by a prescribed protocol, and then the point generation device 2 receives the device authentication from the portable terminal 1 (step S62). Next, the point generation device 2 carries out the device authentication of the portable terminal 1 (step S63). If the device authentication fails, the error output is made (steps S64, S65).

If the device authentication succeeds, next the control unit 22 makes an inquiry of the portable terminal ID to the portable terminal 1, and acquires the portable terminal ID via the transmission and reception unit 23 (step S66). When the portable terminal ID is acquired, the control unit 22 transmits the portable terminal ID to the portable terminal ID verification unit 19, and the portable terminal ID verification unit 19 judges whether this portable terminal ID is revoked or not by searching through the portable terminal revocation list 20 (step S67). Here, if the portable terminal 1 is revoked, the output indicating it is a watch out customer is made and the processing is finished (step S68). The portable terminal revocation list 20 registers all the portable terminal IDs in their transaction stopping periods resulting from the past commitment of the illegal point data transaction. For this reason, if the portable terminal ID is registered in this list, the transaction must be finished at that point.

If it is not revoked, the granted points for the portable terminal 1 is entered (step S69), and then the control unit 22 in the point generation device 2 acquires the store ID, the store clerk ID and the public key certificate of the store clerk recorded in the store clerk card 6, from the store clerk card reading unit 11 (steps S70 to S72). Here, the store clerk card 6 is an electronic identity certificate of the store clerk, which is usually implemented in a form of an IC card. The store clerk must insert the own store clerk card 6 into a card reader of the point generation device 2 whenever operating the point generation device 2. In this way, the responsibility of the store clerk regarding the point service can be clarified, and the illegal person can be eliminated.

The store ID and the store clerk ID acquired from the store clerk card 6 are transmitted to the portable terminal 1 via the transmission and reception unit 23 (step S73), and whether this store or this store clerk is revoked or not is checked at the portable terminal 1 side. Here, if it is revoked, the portable terminal 1 transmits an information indicating the transaction interruption immediately to the point generation device 2, so that the point generation device 2 makes the error output and the processing is finished (steps S74, S75).

If it is not revoked, the processing is shifted to the control unit 22 of the point generation device 2, and the control unit 22 receives the granted points supplied from the accounting device (not shown), and commands the point data generation unit 12 to produce the granted point data. The point data generation unit 12 produces the granted point data body as shown in FIG. 5 by utilizing the earlier acquired store ID, store clerk ID, public key certificate of the store clerk, and portable terminal ID (step S76).

Next, the store clerk secret key is extracted from the store clerk card 6 via the control unit 22, and the digital signature with respect to the granted point data body is produced (step S77). The granted point data as shown in FIG. 5 is completed by attaching the granted point authentication data containing this digital signature to the granted point data, and transmitted to the portable terminal 1 (step S78). When there is a notification indicating that it is received normally from the portable terminal 1, this granted point data is transmitted to the store point server 3 and the processing is finished. If it is not received normally, the error output is made (steps S79 to S81).

Here, the authentication processing will be described in detail. The device authentication in this embodiment is carried out in order to guarantee that the correspondent is not an illegal device. As already mentioned above, in this embodiment, it is regarded sufficiently reliable if the tamper resistance can be assumed for the portable terminal 1 and the point generation device 2.

In other words, the device for which the tamper resistance cannot be assumed, which can be relatively easily hacked by a specific method and in which the data inside the device can be rewritten or read out without any permission, is not a reliable device. The security at a level that warrants the practice of the point service cannot be guaranteed with such a device that is no longer reliable, so that the device authentication is carried out in order to eliminate those devices which are not allowed to be used in the point service system.

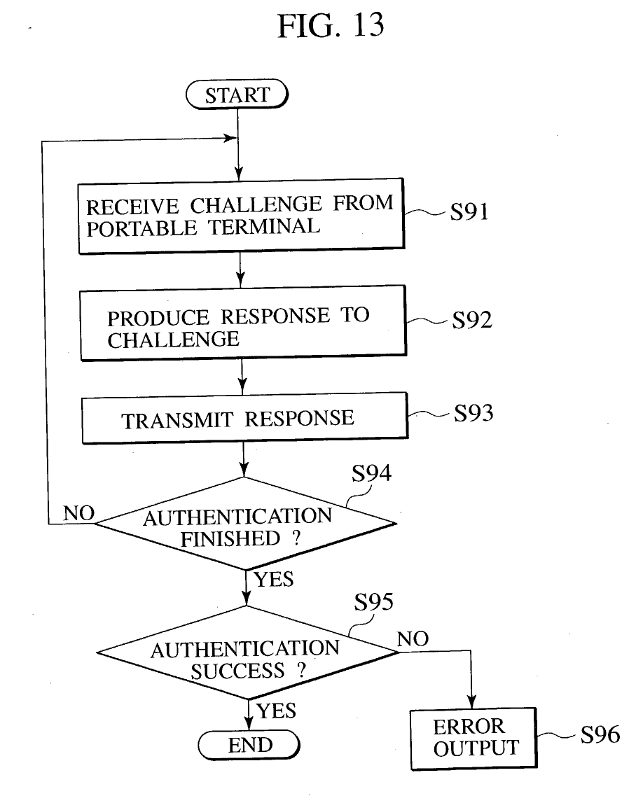

FIG. 13 shows an exemplary authentication algorithm. First, the point generation device 2 receives a challenge from the portable terminal 1 at the transmission and reception unit 23 (step S91). The received challenge is sent to the device authentication unit 16 via the control unit 22. Here, the challenge is an inquiry from the portable terminal 1 to the point generation device 2. There are two types of inquiries, including an inquiry for simply inquiring the device ID of the point generation device 2, and an inquiry that can only be answered by using information that cannot be known by any device other than the point generation device 2.

In the case of the former inquiry, the device authentication unit 16 acquires the device ID from the device data storage unit 18 and transmits it to the portable terminal 1 via the control unit 22 and the transmission and reception unit 23.

In the case of the latter inquiry, the device authentication unit 16 similarly extracts a secret data from the device data storage unit 18 and carries out the processing specified by the challenge. More specifically, the latter inquiry is a command for generating the digital signature for a transmitted plaintext (message) by utilizing the secret key of the public key cryptosystem that is secretly held by the device. Note that the device authentication described here is basically carried out with respect to a model name of the device, for example, and not with respect to the individual device. Namely, the devices of the same model name has the identical device ID and the identical secret key (for authentication), so that they are authenticated by the identical criteria.

A response produced by the device authentication unit 16 is transmitted to the portable terminal 1 from the transmission and reception unit 23 via the control unit 22 (steps S92, S93). In response to the response sent from the point generation device 2, a notification regarding whether the authentication should be finished or continued is received from the portable terminal 1, and if it is the notification of the authentication finishing, whether it is the authentication success or not is judged at the control unit 22, and if it is the authentication failure, its reason is outputted and the processing is finished (steps S94 to S96). Here, the judgement as to whether it is the authentication success or not can be made according to whether an error code is attached to the finishing notification from the portable terminal 1 or not, for example. In the case where the error code is attached, it is the authentication failure and it implies that the authentication failed for the reason indicated by this error code. In the case of the authentication failure, the error output is made according to this error code.

On the other hand, in the case where the authentication is not finished, a next challenge transmitted from the portable terminal 1 is waited, and upon receiving this challenge, the similar processing as described above is carried out.

The authentication algorithm of FIG. 13 can be applied to the processing of the device authentication, etc.

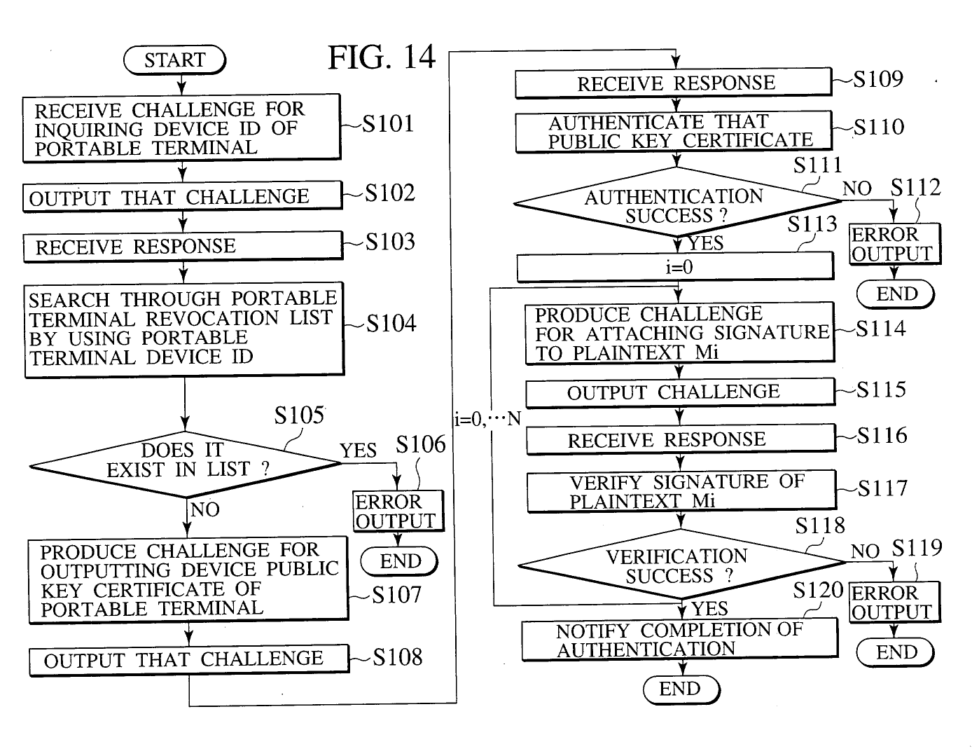

FIG. 14 shows an exemplary algorithm for the device authentication in the point generation device 2. When the authentication process for authenticating the point generation device 2 from the portable terminal 1 is finished, the control unit 22 in the point generation device 2 commands the device authentication unit 16 to carry out the authentication of the portable terminal 1. Upon receiving this command, the device authentication unit 16 first produces a challenge for inquiring the device ID indicating the model number of the portable terminal 1 (step S101), and outputs it to the portable terminal 1 via the control unit 22 and the transmission and reception unit 23 (step S102).

Next, the response of the portable terminal 1 with respect to that challenge is waited, and when the response is received (step S103), the device ID of the portable terminal 1 is extracted from the response, and whether this device ID is registered in the device revocation list 17 or not is verified (step S104). If this device ID is registered in that list, this portable device 1 is either a device for which the security system is already broken down or a device which does not have the prescribed security system so that it is judged as not reliable, and the error message indicating the finishing of the authentication is outputted and the processing is finished (steps S105, S106).

Here, if the device ID of this portable terminal 1 is not registered in the revocation list, the reliability of this portable terminal 1 at least as a device is recognized, so that next the processing proceeds to the verification of whether the device ID of this portable terminal 1 is truly that of this portable terminal 1 or not. For this purpose, it suffices to carry out the authentication utilizing information that cannot be known by any device other than the portable terminal 1 of the same model number, as mentioned above. Namely, a challenge for inquiring the public key certificate of the device ID of this portable terminal 1 is produced (step S107), and this challenge is sent to the portable terminal 1 by the similar method (step S108), and a response from the portable terminal 1 is received (step S109). This public key certificate at the step S107 is for the device authentication of the portable terminal 1, which has a data structure as shown in FIG. 9.

Upon receiving the response from the portable terminal 1, the public key certificate is acquired from the response, and the device ID is acquired from the public key certificate and compared with the device ID of the earlier response. As a result of the comparison, if they do not coincide, the error output indicating that there is an error in either the public key certificate or the device ID is made and the authentication is finished. If they coincide, the public key certificate is authenticated by using the public key of the certificate authority 5. If the authentication succeeds, it is proven that the public key certificate is authentic, so that the processing proceeds to the next challenge. If the authentication fails, the error output indicating that the authentication of the public key certificate failed is made and the authentication processing is finished (steps S110 to S112).

When the authentication of the public key certificate regarding the device ID of the portable terminal 1 succeeds, i=0 is set (step S113), and a challenge for requesting the production of the digital signature that can be verified by this public key with respect to a message Mi is produced and outputted (steps S114, S115). When the response is received (step S116), the signature of the message Mi is verified (step S117).

If the verification fails, the error output indicating that the signature verification failed is made, whereas if the verification succeeds, “i” is sequentially incremented by one while changing the plaintext and the similar challenge and response is repeated N times (steps S118, S119). When the verification succeeds in all of N times, this portable terminal 1 can be recognized as signing the message by using the secret key that is known only by this device ID so that it can be confirmed that it is the portable terminal 1 of this device ID. For this reason, a notification indicating that the authentication succeeded and will be finished is transmitted to the portable terminal 1 (step S120). This completes the processing for the device authentication of the portable terminal 1.

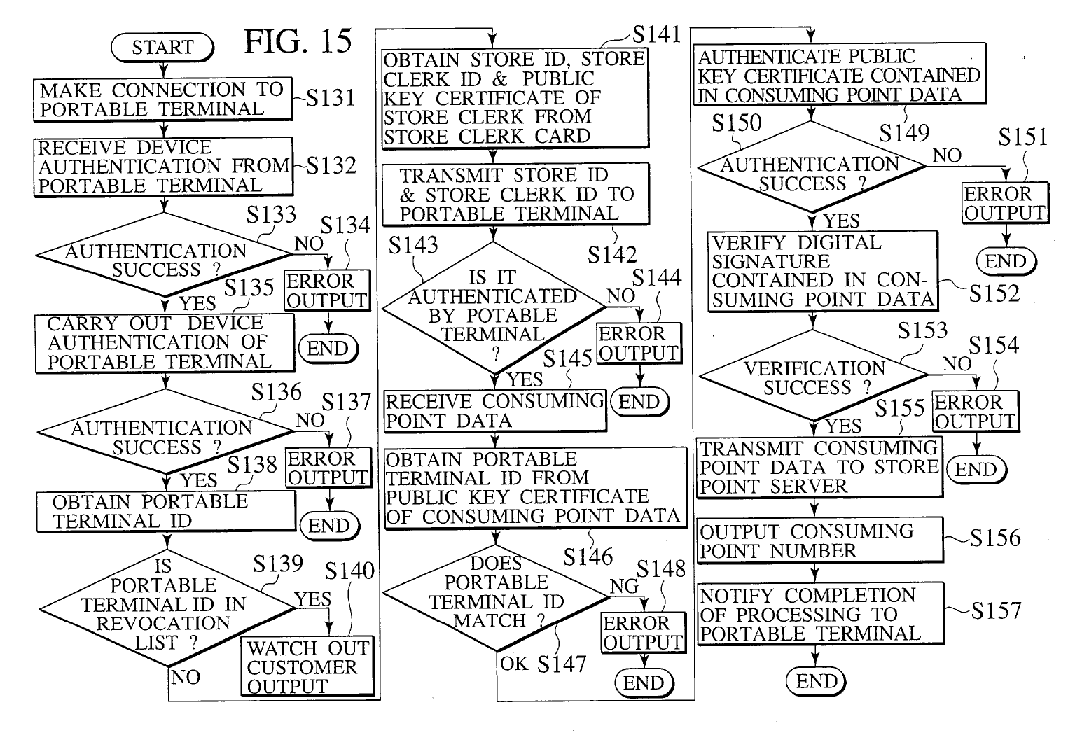

Next, the algorithm for the consuming point data processing to be carried out by the point generation device 2 will be described with reference to FIG. 15. This algorithm has many portions similar to the algorithm for granting points, so that the algorithm of FIG. 12 is also referred and the differences will be mainly described.

At a time of consuming the points, first the point generation device 2 is called up from the portable terminal 1 of the customer, and when the point generation device 2 responds in response to the call up from the portable terminal 1, a connection is made by a prescribed protocol (step S131). When the connection is made, the point generation device 2 receives the device authentication from the portable terminal 1 at the device authentication unit 16 similarly as in the above described algorithm (step S132). If the device authentication fails, the error output is made according to the error code transmitted from the portable terminal 1 and the processing is finished (steps S133, S134).

If the device authentication succeeds, the device authentication of the portable terminal 1 is carried out (step S135). This processing is also similar to the algorithm for the device authentication of the portable terminal 1 in the granting point processing described above, where if the device authentication failed, the error output is made, the error code is also transmitted to the portable terminal 1 and the processing is finished (steps S136, S137), whereas if the device authentication succeeds, the control is shifted to the control unit 22 once, and the control unit 22 commands the portable terminal ID verification processing to the portable terminal ID verification unit 19. The portable terminal ID verification unit 19 carries out the processing to acquire the portable terminal ID from the portable terminal 1 (step S138), and when the portable terminal ID is acquired, whether this portable terminal ID is revoked or not is checked by searching through the portable terminal revocation list 20 (step S139). If it is revoked, the output indicating it is a watch out customer is made and the processing is finished (step S140).

If it is not revoked, the control unit 22 acquires the store ID, the store clerk ID and the public key certificate of the store clerk recorded in the store clerk card 6, from the store clerk card reading unit 11 (step S141).

The store ID and the store clerk ID acquired from the store clerk card 6 are transmitted to the portable terminal 1 via the transmission and reception unit 23 (step S142), and whether this store or this store clerk is revoked or not is checked at the portable terminal 1 (step S143). Here, if it is revoked, the portable terminal 1 transmits an information indicating the transaction interruption immediately to the point generation device 2, so that the point generation device 2 makes the error output and the processing is finished (steps S144).

If it is not revoked, the control unit 22 receives the consuming points supplied from the portable terminal 1 (step S145), and commands the point data verification unit 14 to verify this point data. In the verification of the consuming point data, first the portable terminal ID contained in the consuming point data is acquired (step S146), and compared with the previously transmitted portable terminal ID (step S147). As a result of the comparison, if they do not coincide, there is a possibility that this portable terminal 1 is carrying out the illegal processing, so that the error output indicating that the portable terminal ID contained in the consuming point data does not coincide is made while an output indicating that the verification failed is made to the portable terminal 1 via the control unit 22 and the transmission and reception unit 23, and the processing is finished (step S148).

If they coincide, the public key certificate of the portable terminal 1 is acquired from the consuming point data (step S149), and the public key certificate is authenticated by using the public key of the certificate authority 5 stored in the certificate authority public key storage unit 15. If the authentication fails, it is highly likely that this public key certificate is a counterfeit, so that the error output indicating that the authentication of the public key certificate failed is made while an output indicating that the verification failed is made to the portable terminal 1 via the control unit 22 and the transmission and reception unit 23, and the processing is finished (steps S150, S151).

If the authentication of the public key certificate succeeds, the authenticity of this public key is proven by the third party organization in a form of the certificate authority 5, so that the digital signature of the consuming point data is verified by using this public key (step S152). If the verification fails, it is highly likely that the consuming point data is altered, so that the error output indicating that the verification of the digital signature of the consuming point data failed is made while an output indicating that the verification failed is made to the portable terminal 1 via the control unit 22 and the transmission and reception unit 23, and the processing is finished (steps S153, S154).

If the verification of the digital signature of the consuming point data succeeds, the consuming point data itself is transmitted to the store point server 3, and the consuming point data verification processing is finished and the processing is shifted to the control unit 22 (step S155).

The control unit 22 outputs the consuming point number to the external accounting device via the point number input/output unit 21, and carries out the discount processing (step S156). In addition, when these series of the processings are finished, the processing finish notice is made to the portable terminal 1 and all the processings are finished (step S157).

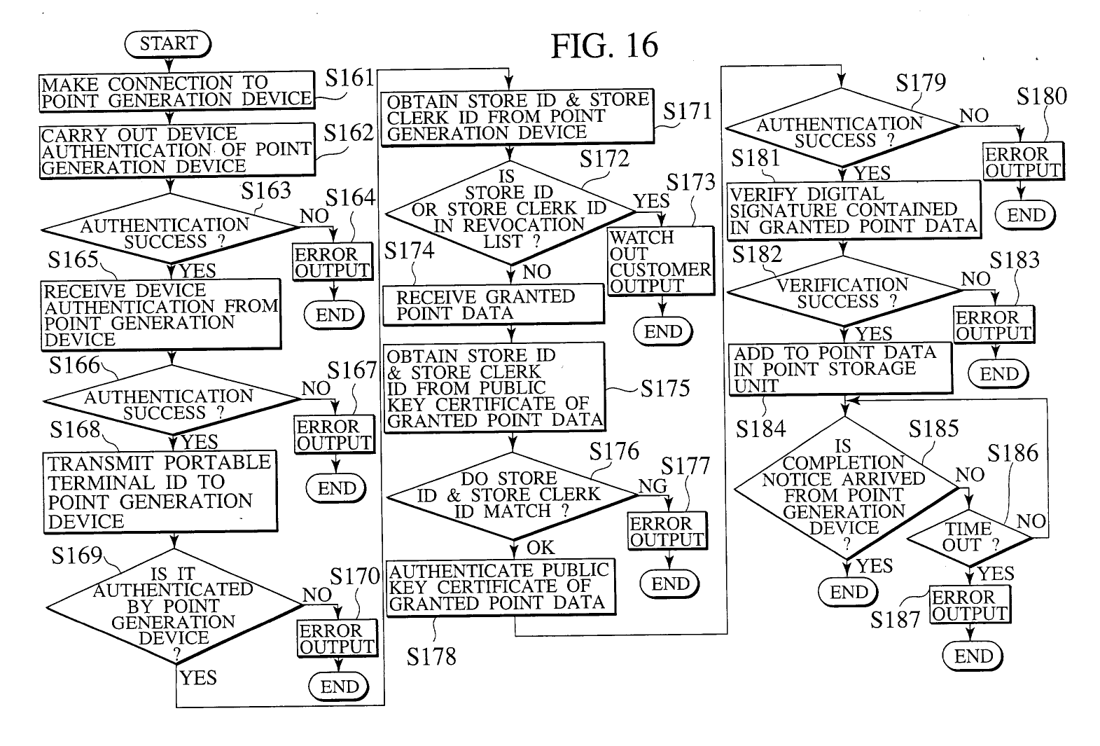

Next, the exemplary granted point data processing at the portable terminal 1 will be described with reference to FIG. 16.

First, the point generation device 2 is called up by a communication from the portable terminal 1 of the customer and a connection is made (step S161). When the connection is made, the mutual authentication with the point generation device 2 is carried out similarly as in the algorithm for the point generation device 2, and if the authentication fails, the error output is made and the processing is finished (steps S162 to S167).

When the device authentication succeeds, the control unit 44 in the portable terminal 1 requests an output of the portable terminal ID to the point data generation unit 31, and the point data generation unit 31 acquires the portable terminal ID from the portable terminal ID storage unit 32 and gives it to the control unit 44 (step S168). The acquired portable terminal ID is transmitted to the point generation device 2 via the transmission and reception unit 45, and the authentication of the portable terminal ID utilizing the revocation list is carried out by the point generation device 2 (step S169).

If the authentication fails, the error output is made and the processing is finished (step S170), whereas if the authentication succeeds, the control unit 44 issues a command for carrying out the authentication of the store and the store clerk to the store and store clerk verification unit 38. Upon receiving this command, the store and store clerk verification unit 38 requests an output of the store ID and the store clerk ID to the point generation device 2 via the control unit 44 and the transmission and reception unit 45, and searches through the store and store clerk revocation list 39 by using the acquired store ID and store clerk ID, to check whether the store of this store ID or the store clerk of this store clerk ID in that store is revoked or not (steps S171, S172).

Here, if it is revoked, the error output indicating that it is a watch out store clerk is made and the processing is finished (step S173). If it is not revoked, it is judged as the verification success, and the processing is shifted to the control unit 44.

Next, the control unit 44 receives the granted point data from the point generation device 2 (step S174), and transmits this granted point data to the point data verification unit 33, to carry out the verification of the granted point data.

In the verification of the granted point data, first the store ID and the store clerk ID are acquired from the granted point data (step S175), and compared with the previously transmitted store ID and store clerk ID (step S176). As a result of the comparison, if they do not coincide, there is a possibility that this point generation device 2 is carrying out the illegal processing, so that the error output indicating that the store ID and the store clerk ID recorded in the granted point data do not coincide with the actual store ID and store clerk ID is made while an output indicating that the verification failed is made to the point generation device 2 via the control unit 44 and the transmission and reception unit 45, and the processing is finished (step S177).

If they coincide, the public key certificate of the store clerk is acquired from the granted point data, and the public key certificate is authenticated by using the public key of the certificate authority 5 stored in the certificate authority public key storage unit 34. If the authentication fails, it is highly likely that this public key certificate is a counterfeit, so that the error output indicating that the authentication of the public key certificate failed is made while an output indicating that the verification failed is made to the point generation device 2 via the control unit 44 and the transmission and reception unit 45, and the processing is finished (steps S179, S180).

If the authentication of the public key certificate succeeds, the verification of the digital signature of the granted point data is carried out (step S181). If the verification fails, it is highly likely that the granted point data is altered, so that the error output indicating that the verification of the digital signature of the granted point data failed is made while an output indicating that the verification failed is made to the point generation device 2 via the control unit 44 and the transmission and reception unit 45, and the processing is finished (steps S182, S183).

If the verification of the digital signature of the granted point data succeeds, the control unit 44 issues a command for adding the granted points to the points, to the point number management unit 41, and the point number management unit 41 adds the granted points to the points stored in the point data storage unit 42 (step S184). In response, the control unit 44 waits for a finishing notice from the point generation device 2 (step S185). When the finishing notice is received, this algorithm is finished at that point. On the other hand, if the finishing notice is not received even after waiting for a prescribed period of time, the error output is made and the processing is finished (steps S186, S187).

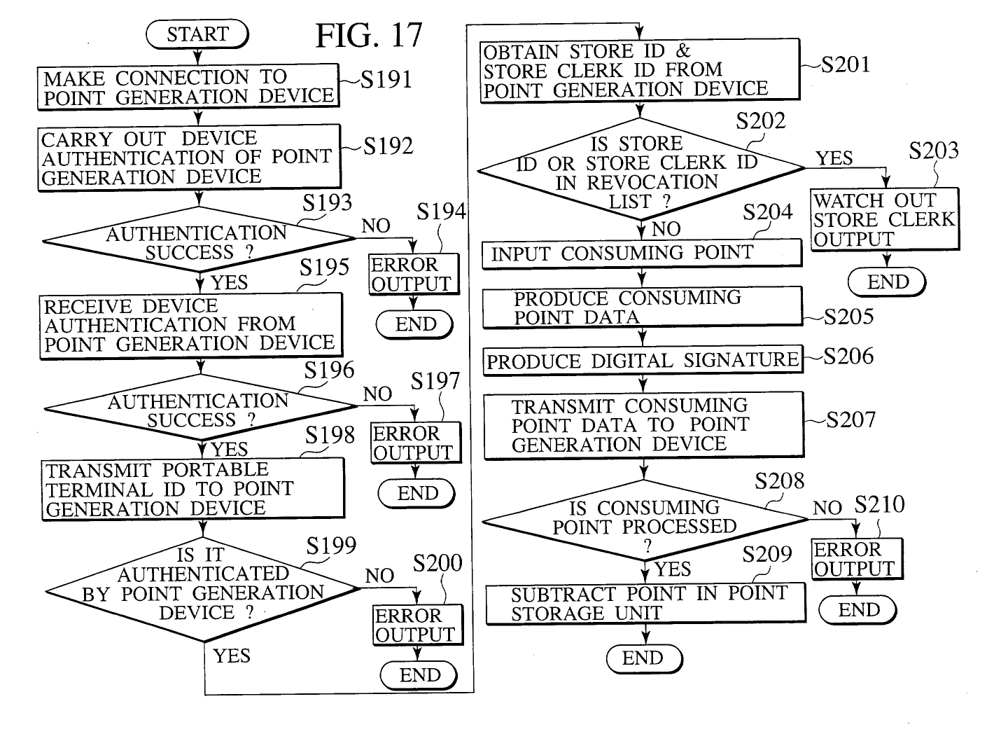

Next, the exemplary consuming point data processing at the portable terminal 1 will be described with reference to FIG. 17.

First, the point generation device 2 is called up by a communication from the portable terminal 1 of the customer and a connection is made (step S191). When the connection is made, the mutual authentication with the point generation device 2 is carried out similarly as in the algorithm for the point generation device 2, and if the authentication fails, the error output is made and the processing is finished (steps S192 to S197).

When the device authentication succeeds, the control unit 44 in the portable terminal 1 requests an output of the portable terminal ID and the public key certificate of the portable terminal 1 to the point data generation unit 31, and the point data generation unit 31 acquires the portable terminal ID and the public key certificate of the portable terminal 1 from the portable terminal ID storage unit 32 and gives them to the control unit 44. The control unit 44 transmits the acquired portable terminal ID to the point generation device 2 (step S198), and the authentication of the portable terminal ID utilizing the revocation list is carried out by the point generation device 2 (step S199). If the authentication fails, the error output is made and the processing is finished (step S200).

If the authentication succeeds, the control unit 44 issues a command for carrying out the authentication of the store and the store clerk to the store and store clerk verification unit 38. Upon receiving this command, the store and store clerk verification unit 38 requests an output of the store ID and the store clerk ID to the point generation device 2 via the control unit 44 and the transmission and reception unit 45, and searches through the store and store clerk revocation list 39 by using the acquired store ID and store clerk ID, to check whether the store of this store ID or the store clerk of this store clerk ID in that store is revoked or not (steps S201, S202). Here, if it is revoked, the error output indicating that it is a watch out store clerk is made and the processing is finished (step S203). If it is not revoked, it is judged as the verification success, and the processing is shifted to the control unit 44.

Next, the control unit 44 receives an input of the consuming points from the point number input/output unit 43 (step S204) and sends the earlier acquired portable terminal ID, store ID, store clerk ID and consuming points to the point data generation device 31, and the point data generation unit 31 produces the consuming point data body by using them (step S205).

Also, the public key is acquired from the public key certificate of the portable terminal 1, and the digital signature with respect to the consuming point data body is produced (step S206), to produce the consuming point data, and this consuming point data is transmitted to the point generation device 2 via the control unit 44 and the transmission and reception unit 45 (step S207).

Then, when there is a notification indicating the normal finishing of the processing from the point generation device 2, the control unit 44 issues a command for subtracting the points as much as the consuming points to the point number management unit 41, and the point number management unit 41 subtracts the points in the point data storage unit 42 as much as the consuming points, and all the processings are finished (steps S208, S209).

On the other hand, when there is an error input from the point generation device 2 or when there is no response within a prescribed period of time, the points are not subtracted and the processing is finished (step S210).

Next, the processing of the main point server 4 will be described. The main point server 4 collects the point data (granted point data and consuming point data) from the store point server 3 at a prescribed interval, such as at a closing time of each business day, for example, and stores the collected point data into the point data DB 57 via the point data management unit 58. These point data are checked to verify whether there is any illegal transaction or not, and the illegal person is identified from the portable terminal ID, the store ID and the store clerk ID of the point data.

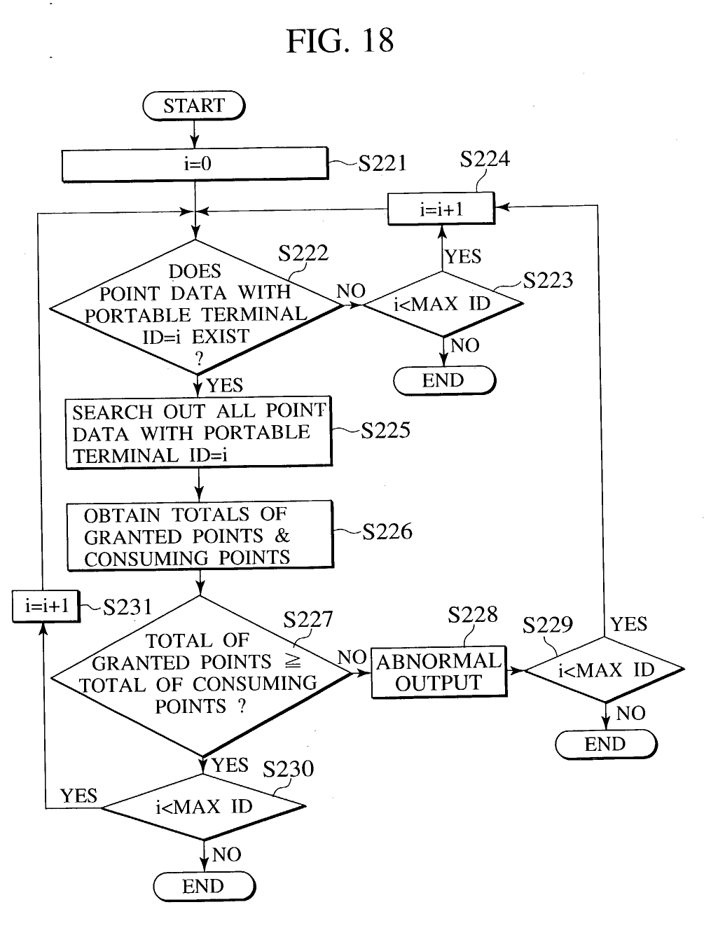

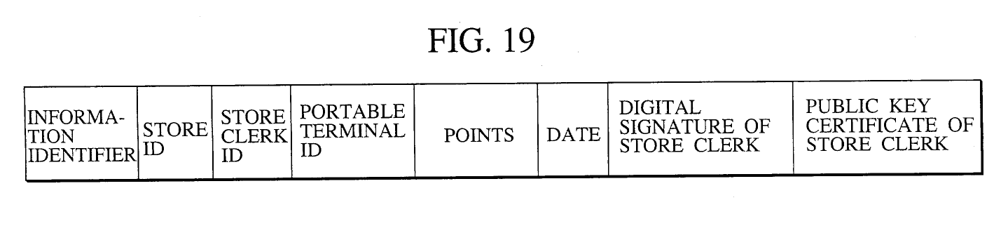

First, the point checking processing of the main point server 4 will be described with reference to FIG. 18. Here, it is assumed that all the portable terminal IDs are set between 0 and MAXID. This algorithm is started by the control unit 61 when the collection of the point data from the stores is completed. The control unit 61 commands the point data checking unit 59 to check the point data. Upon receiving this command, the point data checking unit 59 sets i=0, and starts the check (step S221).

Next, the existence of the point data that contains “i” as the portable terminal ID is checked by searching through the point data DB 57 (step S222). If a point data that contains such a portable terminal ID does not exist, after confirming that i<MAXID, “i” is incremented by one and the existence of the point data is searched again. Here, if i=MAXID, it implies that the processing is finished entirely (steps S223, S224).

When the point data that contains “i” as the portable terminal ID exists in the point data DB 57, all such point data are extracted by searching through all the point data (step S225). Then, a total of their granted points and a total of their consuming points are obtained (step S226).

Whether this data is the granted point data or the consuming point data can be distinguished by their information identifiers. Here, if the total of the consuming points is greater than the total of the granted points, it can be considered that some illegal act occurred, so that a notice indicating that this portable terminal ID is abnormal is outputted to the check result output unit 60 (steps S227 to S229). When the total of the consuming points is less than the total of the granted points, it is normal so that nothing is outputted. In either case, the processing proceeds to the search for the next portable terminal ID similarly as described above, and the processing is finished when there is no next portable terminal ID (steps S230, S231).

For the portable terminal ID that is judged as abnormal as a result of the check, the cause of the abnormality is checked by searching through the point data DB 57 by using the interface of the revocation list input/output unit 63, and the illegal person is identified. Here, the care must be taken that the illegal person is not necessarily the owner of the portable terminal 1, because there is a possibility that the store clerk is doing the illegal utilization by copying the data of the user.

In the latter case, the criminal can be identified from the fact that the store clerk ID of the consuming point data is always the same person. For this reason, it is difficult to realize the automatic implementation of the processing for identifying the illegal person, without errors.

Note that, when the illegal person is identified, it is registered into one of the revocation list DBs 51, 53 and 55 by utilizing the revocation list input/output unit 63, via the store and store clerk revocation list management unit 54 if it is the illegal act of the store or the store clerk, via the portable terminal revocation list management unit 56 if it is the illegal act of the user, or via the device revocation list management unit 52 if it is the hacking of the device.

In order to reflect these revocation lists on the actual portable terminal 1 and point generation device 2, the following processing can be carried out. First, for the point generation device 2, either new device revocation list 17 and portable terminal revocation list 20 are transmitted to each point generation device 2 via the store point server 3 before the opening time of each business day, for example, or their differences from yesterday are transmitted. For the portable terminal 1, the device revocation list 37 and the store and store clerk revocation list 39 can be updated though a public channel at a rate of about once a month, or the portable terminal 1 itself can download them from the home page on the Internet.

As described, in the first embodiment, whether the granted point data produced by the point generation device 2 is illegal or not is authenticated by the portable terminal 1, and whether the consuming point data produced by the portable terminal 1 is illegal or not is authenticated by the point generation device 2, so that the illegal act by at least one of the portable terminal 1 and its user, the point generation device 2, and the store and the store clerk can be discovered surely, so that it is possible to prevent the illegal point transaction.

In the first embodiment described above, the granted point data shown in FIG. 5 and the consuming point data shown in FIG. 6 contain the store ID and the store clerk ID, but it is also possible to use either one of them alone. It is also possible to omit the public key certificate in the case where the number of customers is limited, or in the case where the database for storing the customer information is substantial.

There are several modifications that can be made on the first embodiment described above.

The first modified embodiment is to add the date information to the granted point data and the consuming point data. The date information is not indispensable in the present invention, but there can be cases where the presence of the date information can make it very easier to identify the illegal person. The addition of the date information require hardly any change in each device configuration and algorithm.

The second modified embodiment is to add the user ID instead of the portable terminal ID in the granted point data and the consuming point data. By doing this, even when the illegal person changes the portable terminal 1, the illegal person can be revoked surely. However, in order to realize this, there is a need to request the user side to own an IC card which records the user specific information. For this reason, it requires cost and it may be difficult to widely spread in some cases. Also, in the case of applying this modified embodiment to the portable telephone, the IC card such as SIM card will be utilized rather than the ordinary IC card. Note that this modified embodiment can also be realized without hardly any change to the each device configuration and algorithm.

The third modified embodiment is the case of using no revocation. When the revocation is omitted, it may appear that the illegal person can be only identified and cannot be caught. However, if the service can be started by registering the users, the stores, and the store clerks thoroughly in advance, the compensation for the illegal act can be directly demanded to the illegal person according to the illegal person's address or the like. In addition, all the processings regarding the revocation described above can be omitted, so that it becomes possible to provide the easy and quick service. In practice, some of the services that utilize the radio communication function of the current portable terminal 1 have the problem of the processing time required for the service, and this modified embodiment can be effective in such cases.

The fourth modified embodiment is to apply the encryption on the communication data including the granted point data and the consuming point data. By such an encryption, data such as the portable terminal ID, the store ID, the store clerk ID, and the granted or consuming points contained in the point data are also encrypted, so that the privacy violation by the third person who eavesdrops the communication can be prevented. Namely, when these data are eavesdropped, it becomes possible to ascertain who (portable terminal ID) is granted (consuming) how many points at where (store ID, store clerk ID), which can be a serious privacy violation from a viewpoint of the customer.

Conversely, the system from which these data can be leaked easily cannot be trusted by the customers and has a possibility of being shunned. This modified embodiment can be significant in this regard.

Schemes for encryption/decryption include a scheme using the public key cryptosystem in which the encryption is done by using the public key of the correspondent and the decryption is done at the receiving side by using the secret key (which is secretly held by the receiving side). This scheme is the most basic scheme, which has no problem when the data is small, but when the data becomes larger than one block of the public key cryptosystem (64 bytes in the RSA cryptosystem and 10 bytes in the elliptic curve cryptosystem, the encryption/decryption requires time and its utilization becomes difficult.

In such a case of transmitting the data larger than one block of the public key cryptosystem, there is a method in which the encryption key of the common key cryptosystem such as DES or AES is transmitted by using the public key cryptosystem immediately after the connection is made, and the actual encryption/decryption is carried out by using this encryption key, Besides these, there is also a proposition of the Diffie-Hellman key exchange protocol for exchanging the common key of the common key cryptosystem safely, by ingeniously utilizing the mechanism of some type of the public key cryptosystem.

By utilizing these encryption schemes, at least a portion from the store ID up to the granted points can be encrypted and transmitted in the case of the granted point data of FIG. 5, and at least a portion from the portable terminal ID up to the consuming points can be encrypted and transmitted in the case of the consuming point data of FIG. 6, such that it is possible to provide a protection against the privacy violation by the third person who is capable of eavesdropping the communication.

Also, the processing flow in this modified embodiment can be realized by modifying the processing of the first embodiment described above such that a common key is shared by either transmitting the public key immediately after the connection is made or by using the Diffie-Hellman key exchange protocol, the encryption processing by using this public key or this common key is added at a stage of transmitting each data in the subsequent processing, and the decryption processing is added after the data are received at the receiving side.

Of course, the data to be transmitted or received include a message for the signature challenge in the device authentication and the signature with respect to it, which are data that do not cause any privacy violation. It is possible to use a further modification to carry out the processing in which the encryption is not applied to those data which do not cause the privacy violation, in order to realize the high speed processing.

Referring now to FIG. 19 to FIG. 25, the second embodiment of a point management system according to the present invention will be described in detail.

The second embodiment is directed to the case where the authentication of the point data is carried out only at the point generation device 2.

In the second embodiment, there is only one type of the point data, and its data structure contains the information identifier, the store ID, the store clerk ID, the portable terminal ID, the points, the date information, the digital signature of the store clerk, and the public key certificate of the store clerk, as shown in FIG. 9. Among them, elements other than the points and the date information are the same as those of the first embodiment so that their description will be omitted.

The points used in FIG. 19 do not distinguish the granted points and the consuming points, and represent the total points currently possessed by the portable terminal 1. Note that the digital signature of the store clerk is produced by the store clerk of the store clerk ID, with respect to data from the information identifier up to the date information. In the following, a portion (from the information identifier up to the date information) that is a target of the digital signature will be referred to as a point data body.

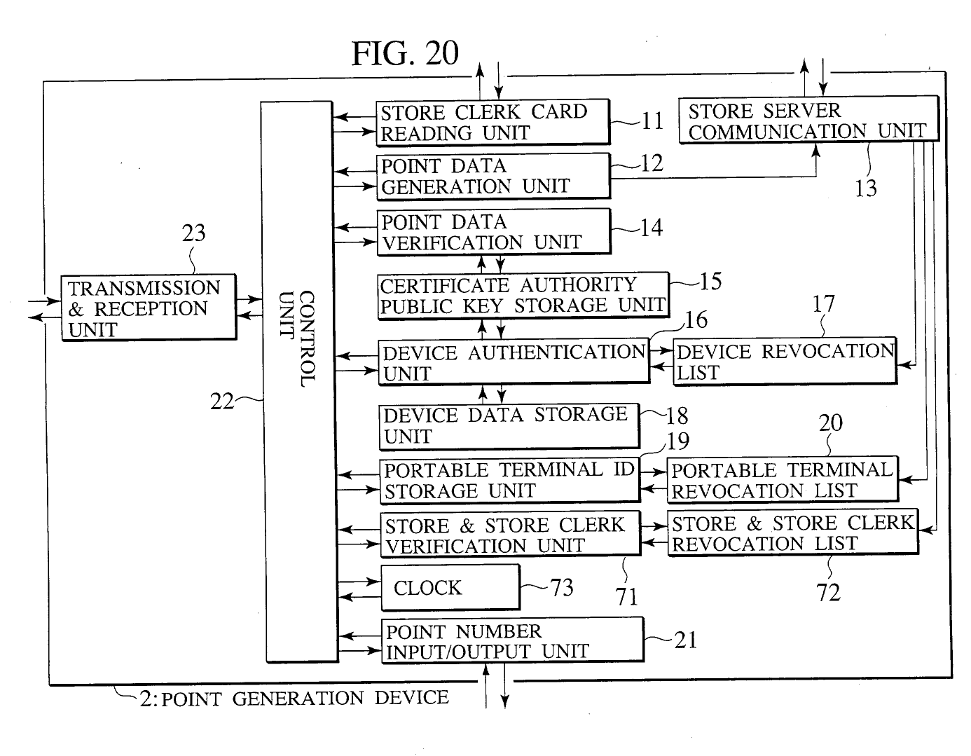

FIG. 20 shows a schematic configuration of the point generation device 2 according to the second embodiment. In the point generation device 2 of FIG. 20, a store and store clerk verification unit 71, a store and store clerk revocation list 72, and a clock 73 are added to the configuration of FIG. 2.

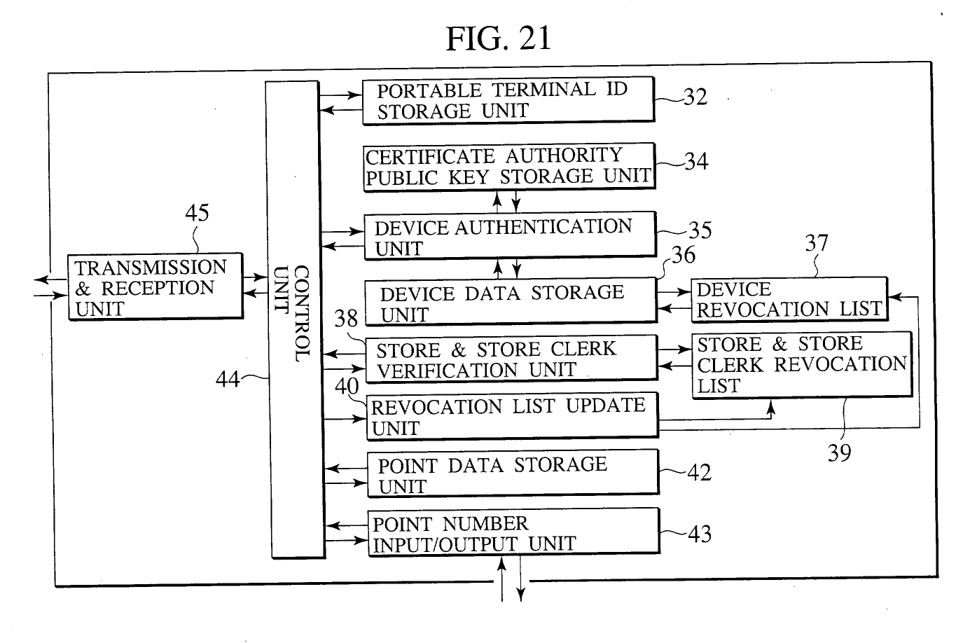

FIG. 21 shows a schematic configuration of the portable terminal 1 according to the second embodiment. The portable terminal 1 of FIG. 21 differs from the portable terminal 1 of FIG. 3 in that the point data generation unit 31, the point data verification unit 33, and the point number management unit 41 are omitted.

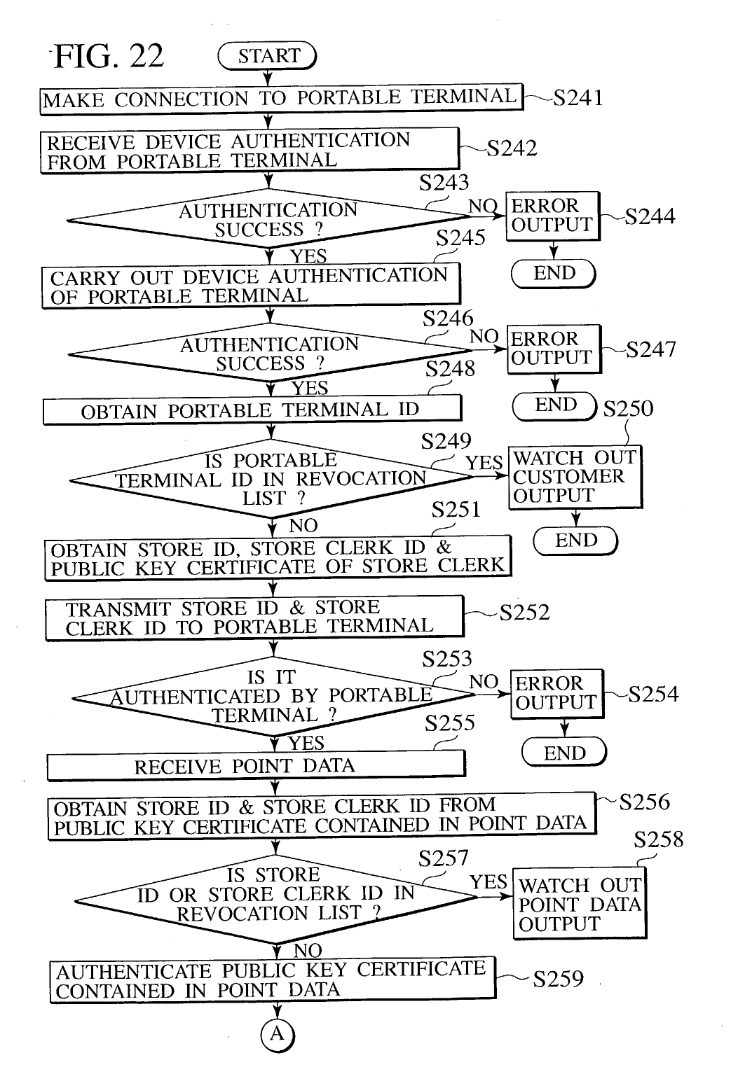

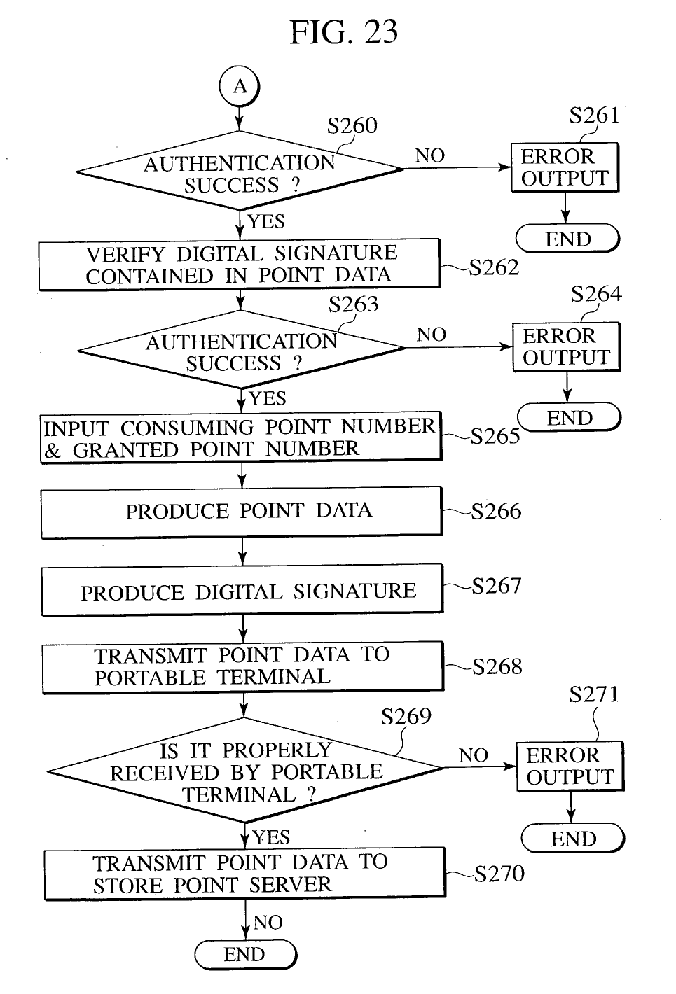

FIG. 22 and FIG. 23 show the exemplary point data processing to be carried out by the point generation device 2 of FIG. 20.

First, the point generation device 2 is called up by a communication from the portable terminal 1 of the customer and a connection is made (step S241). When the connection is made, the mutual authentication with the portable terminal 1 is carried out, and if the authentication fails, the error output is made and the processing is finished (steps S242 to S247).

When the device authentication succeeds, the control unit 22 commands the portable terminal ID verification processing to the portable terminal ID verification unit 19. The portable terminal ID verification unit 19 carries out the processing for acquiring the portable terminal ID from the portable terminal 1 (step S248), and when the portable terminal ID is acquired, whether this portable terminal ID is revoked or not is checked by searching through the portable terminal revocation list 20. Here, if it is revoked, the output indicating that it is a watch out customer is made and the processing is finished (steps S249, S250).

If it is not revoked, the control unit 22 acquires the store ID, the store clerk ID and the public key certificate of the store clerk recorded in the store clerk card 6, from the store clerk card reading unit 11 (step S251). The store ID and the store clerk ID acquired from the store clerk card 6 are transmitted to the portable terminal 1 via the transmission and reception unit 23 (step S252), and whether this store or this store clerk is revoked or not is checked at the portable terminal 1 (step S253). Here, if it is revoked, the portable terminal 1 transmits an information indicating the transaction interruption immediately to the point generation device 2, so that the point generation device 2 makes the error output and the processing is finished (steps S254).

If it is not revoked, the point data from the portable terminal 1 is received (step S255). The point data is transmitted from the control unit 22 to the store and store clerk verification unit 38, and the store and store clerk verification unit 38 searches through the store and store clerk revocation list 39, to check whether at least one of the store ID and the store clerk ID contained in this point data is revoked or not (steps S256, S257).

In this embodiment, the point data can be produced only by the point generation device 2, so that the point data has the store ID and the store clerk ID. The reliability of the point data depends on the store and the store clerk which produced that point data, so that the revocation as described above is necessary. Here, if that store ID or that store clerk ID of the store having that store ID is revoked, the output indicating that it is a watch out point data is made and the processing is interrupted (step S258).

If it is not revoked, the processing is shifted to the control unit 22 once, and the control unit 22 transmits this point data to the point data verification unit 14, to carry out the verification of the point data (step S259).

In the verification of the point data, the public key certificate of the store clerk is acquired from the point data, and the public key certificate is authenticated by using the public key of the certificate authority 5 stored in the certificate authority public key storage unit 15. If the authentication fails, it is highly likely that this public key certificate is a counterfeit, so that the error output indicating that the authentication of the public key certificate failed is made while an output indicating that the verification failed is made to the point generation device 2 via the control unit 22 and the transmission and reception unit 23, and the processing is finished (steps S260, S261).

If the authentication of the public key certificate succeeds, the verification of the digital signature of the point data is carried out (step S262). If the verification fails, it is highly likely that the point data is altered, so that the error output indicating that the verification of the digital signature of the point data failed is made while an output indicating that the verification failed is made to the portable terminal 1 via the control unit 22 and the transmission and reception unit 23, and the processing is finished (steps S263, S264).

If the verification of the digital signature of the point data succeeds, the control unit 22 outputs the consuming point number specified from the user to the external accounting device via the point number input/output unit 21. The external accounting device transmits the granted point number in the case of making discount for the consuming point number to the point number input/output unit 21 (step S265). The point number input/output unit 21 transmits this granted point number to the control unit 22, and the control unit 22 calculates a resulting point number from the consuming point number and the granted point number, and reflects it on the current point number.

The points contained in the point data of the present invention is the total point number currently possessed by the portable terminal 1, and the processing here is to calculate the total point number after this transaction according to the consuming points and the granted points determined by this transaction and the currently possessed total point number.

Next, the control unit 22 reads the current time from the clock 73, and transmits that time, and the calculated total point number, as well as the store ID and the store clerk ID read earlier from the the store clerk card 6, and the portable terminal ID received from the portable terminal 1, to the point data generation unit 12, and then issues a command for producing a new point data.

Upon receiving this command, the point data generation unit 12 produces the point data body from these data (step S266). In addition, the public key is acquired from the public key certificate of the store clerk, and the point authentication data containing the digital signature for that point data body by using that public key (step S267), and then the point data is completed by attaching this point authentication data to the point data body, and transmits the point data to the control unit 22.

Upon receiving this point data, the control unit 22 transmits the point data to the portable terminal 1 via the transmission and reception unit 23 (step S268). The transmitted point data is processed at the portable terminal 1 according to the algorithm to be described below, and when this processing is finished, a notification indicating that this point data is correct from the portable terminal 1 reaches the point generation device 2. Upon receiving this notification, the point generation unit 2 transmits the point data to the store point server 3 (steps S269, S270). Here if the error message from the portable terminal 1 or there is no response after elapse of a prescribed period of time, the control unit 22 makes the error output and finishes the processing without transmitting the point data to the store point server 3 (step 271).

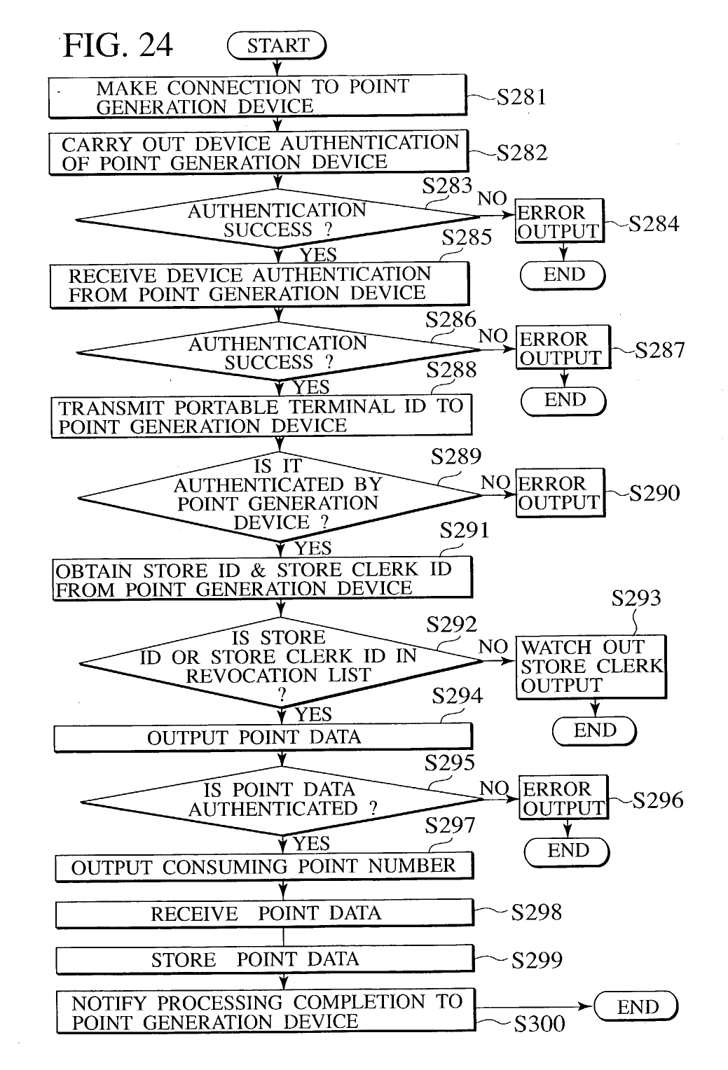

Next, the exemplary point data processing to be carried out by the portable terminal 1 of the second embodiment will be described with reference to FIG. 24.

First, the point generation device 2 is called up by a communication from the portable terminal 1 of the customer and a connection is made (step S281). When the connection is made, the mutual authentication with the point generation device 2 is carried out, and if the authentication fails, the error output is made and the processing is finished (steps S282 to S287).

When the device authentication succeeds, the control unit 44 requests an output of the portable terminal ID and the public key certificate of the portable terminal 1 to the point data generation unit 31, and the point data generation unit 31 acquires the portable terminal ID and the public key certificate of the portable terminal 1 from the portable terminal ID storage unit 32 and gives them to the control unit 44.

The control unit 44 transmits the acquired portable terminal ID to the point generation device 2 (step S288), and the authentication of the portable terminal ID utilizing the revocation list is carried out by the point generation device 2 (step S289). If the authentication fails, the error output is made and the processing is finished (step S290).

If the authentication succeeds, the control unit 44 issues a command for carrying out the authentication of the store and the store clerk to the store and store clerk verification unit 38. Upon receiving this command, the store and store clerk verification unit 38 requests an output of the store ID and the store clerk ID to the point generation device 2 via the control unit 44 and the transmission and reception unit 45, and searches through the store and store clerk revocation list 39 by using the acquired store ID and store clerk ID, to check whether the store of this store ID or the store clerk of this store clerk ID in that store is revoked or not (steps S291, S292). Here, if it is revoked, the error output indicating that it is a watch out store clerk is made and the processing is finished (step S293). If it is not revoked, it is judged as the verification success, and the processing is shifted to the control unit 44.

Next, the control unit 44 acquires the point data from the point storage unit 42, and transmits the point data to the point generation device 2 via the transmission and reception unit 45 (step S294). After the transmission, if the authentication of this point data by the point generation device 2 fails, the error output is made (steps S295, S296), whereas if there is a notification indicating that this point data is authenticated from the point generation device 2, the control unit 44 acquires the consuming points via the point number input/output unit 43, and transmits the consuming points to the point generation device 2 (step S297). Upon receiving the consuming points, the point generation device 2 carries out the generation of a new point data.

The generated point data is one that is obtained by updating the transmitted point data according to the earlier inputted consuming points and the granted points inputted from the accounting device associated with the point generation device 2. The portable terminal 1 receives this point data (step S298), and the control unit 44 stores this point data into the point storage unit 42 (step S299), and when the storing is confirmed, the notification of the processing finish is made to the point generation device 2, and all the processings are finished (step S300).

As described, in the second embodiment, the portable terminal 1 does not carry out the generation of the point data utilizing its own secret key. The reason for this is that the tamper resistance of the portable terminal 1 is not assumed in the second embodiment, so that the validity of the digital signature utilizing the secret key is not recognized. Namely, it is based on the understanding that, by not producing the point data and carrying out only the device authentication, the correspondent authentication and the storing of the point data at the portable terminal 1, rather than producing the point data attached with the digital signature having no reliability in terms of the security, it becomes possible to make the occurrence of the illegality more difficult, and to realize the faster processing (as one side does not carry out the digital signature production). This is the major feature of this embodiment.

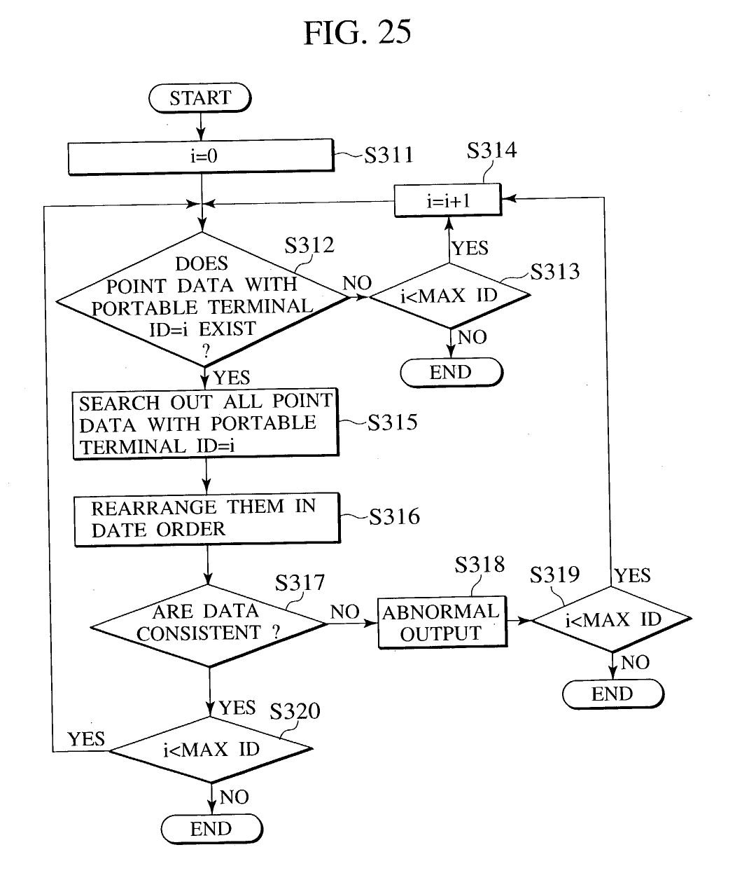

Next, the point data checking processing of the main point server 4 of the second embodiment will be described with reference to FIG. 25. Note that the main point server 4 of the second embodiment has the same configuration as that shown in FIG. 4.

The main point server 4 collects the point data from the store point server 3 at a closing time of each business day, and the collected point data are stored into the point data DB 57 via the point data management unit 58 in the main point server 4. The processing of FIG. 25 is started by the control unit 61 in the main point server 4 when the storing of the point data from the stores into the point data DB is completed. The control unit 61 commands the point data checking unit 59 to check the point data. Upon receiving this command, the point data checking unit 59 sets i=0, and starts the check (step S311).

Here, it is assumed that the portable terminal ID has a value between 0 and MAXID. First, the existence of the point data that contains “i” as the portable terminal ID is checked by searching through the point data DB 57 (step S312). If a point data that contains such a portable terminal ID does not exist, after confirming that i<MAXID (step S313), “i” is incremented by one and the existence of the point data is searched again (step S314). Here, if i=MAXID, it implies that the processing is finished entirely.

When the point data that contains “i” as the portable terminal ID exists in the point data DB 57, all such point data are extracted by searching through all the point data (step S315). Then, these point data are rearranged in an ascending order of the date by utilizing the date information contained inside the point data (step S316), and the consistency among the point data is judged (step S317)

The judgement of the consistency is realized by the following algorithm. The point data are checked in an ascending order of the date, and whether the point data issued by the store and the point data received by the (other) store next time are different or not is checked. Here, if they are found to be different, there is a possibility that some illegality occurred in this point data.

For this reason, the for such a point data, a notification indicating that the portable terminal ID of this point data is abnormal is outputted to the check result output unit 60 (step S318). On the other hand, when the consistency is proved, it is normal so that nothing is outputted. In either case, the processing proceeds to the search for the next portable terminal ID similarly as described above, and the processing is finished when there is no next portable terminal ID (step S319, S320).

For the portable terminal ID that is judged as abnormal as a result of the check, the cause of the abnormality is checked by searching through the point data DB 57 by using the interface of the revocation list input/output unit 63, and the illegal person is identified. Here, the care must be taken that the illegal person is not necessarily the owner of the portable terminal 1, because there is a possibility that the store clerk is doing the illegal utilization by copying the data of the user. In the latter case, the criminal can be identified from the fact that the store clerk ID of the point data is always the same person. For this reason, it is difficult to realize the automatic implementation of the processing for identifying the illegal person, without errors.

Note that, when the illegal person is identified, it is registered into one of the revocation list DBs 51, 53 and 55 by utilizing the revocation list input/output unit 63, via the store and store clerk revocation list management unit 54 if it is the illegal act of the store or the store clerk, via the portable terminal revocation list management unit 56 if it is the illegal act of the user, or via the device revocation list management unit 52 if it is the hacking of the device.

In order to reflect these revocation lists on the actual portable terminal 1 and point generation device 2, the following processing can be carried out. First, for the point generation device 2, either new device revocation list 17 and portable terminal revocation list 20 are transmitted to each point generation device 2 via the store point server 3 before the opening time of each business day, for example, or their differences from yesterday are transmitted. For the portable terminal 1, the device revocation list 37 and the store and store clerk revocation list 39 can be updated though a public channel at a rate of about once a month, or the portable terminal 1 itself can download them from the home page on the Internet.

As described, in the second embodiment, the authentication of the point data is carried out only by the point generation device 2, so that the configuration of the portable terminal 1 can be simplified and the illegal act utilizing the portable terminal 1 can be prevented surely.

For the second embodiment described above, the first to fourth modified embodiments described in relation to the first embodiment are also applicable. Also, as a modified embodiment specific to this embodiment, it is possible to use a configuration in which the point data verification unit 14 is provided at the portable terminal 1 and the digital signature verification is carried out after the store ID and the store clerk ID of the received point data are checked. This modification is effectively the combination of the first and second embodiments so that the detailed description will be omitted here. This modification is effective in that it becomes possible to discover and reject the illegality of the store or its store clerk at the spot.

As described above, according to the present invention, the fact that both the point data granted at the point generation device and the point data consumed by the portable terminal are not illegal is checked by both the point generation device and the portable terminal, so that the illegal utilization of the point data can be prevented surely. Also, according to the present invention, it is possible to identify a person who granted or consumed the points illegally.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A point generation device for carrying out generation and authentication of point data for a portable terminal, the point generation device comprising:
a granted point data generation unit configured to generate a granted point data having a granted point data body which contains information on a number of points granted to the portable terminal, and a granted point authentication data to be used in authenticating the granted point data body;
a consuming point data authentication unit configured to carry out authentication of a consuming point data having a consuming point data body which contains information on a number of points to be consumed by the portable terminal, and a consuming point authentication data to be used in authenticating the consuming point data body; and
a point data transmission unit configured to transmit the granted point data to the portable terminal and a point management server for managing point data, and transmit the consuming point data to the point management server.

2. The point generation device of claim 1, wherein the granted point data generation unit generates the granted point data body which contains a number of points granted to the portable terminal, an identification information of at least one of a point issuing organization and a point issuing person that grants points, an identification information of at least one of the portable terminal and a user of the portable terminal, and an information for identifying that it is the granted point data;
the granted point data generation unit generates the granted point authentication data which contains a digital signature of at least one of the point issuing organization and the point issuing person with respect to the granted point data body, and a public key certificate of at least one of the point issuing organization and the point issuing person which is certified by a prescribed certificate authority;
the consuming point data authentication unit authenticates the consuming point data body which contains a number of points to be consumed by the portable terminal, an identification information of at least one of the point issuing organization and the point issuing person, an identification information of at least one of the portable terminal and the user of the portable terminal, and an information for identifying that it is the consuming point data; and
the consuming point data authentication unit authenticates the consuming point authentication data which contains a digital signature of at least one of the portable terminal and the user of the portable terminal with respect to the consuming point data body, and a public key certificate of at least one of the portable terminal and the user of the portable terminal which is certified by the prescribed certificate authority.

3. The point generation device of claim 1, further comprising:
a device authentication unit having at least one of a device authentication function for checking a reliability of the portable terminal of each model number, and a user authentication function for checking a reliability of a user of the portable terminal.

4. The point generation device of claim 1, further comprising:
a revocation list registration unit having at least one of a terminal revocation list for registering information regarding specific portable terminals which committed illegal acts in past, and a device revocation list for registering information regarding model numbers of portable terminals which have problems in terms of security; and
a revocation judgement unit configured to prohibit generation or consumption of point data when at least one of the portable terminal and a model number of the portable terminal is registered in the revocation list registration unit.

5. A point generation device for carrying out generation and authentication of point data for a portable terminal, the point generation device comprising:
a total point data authentication unit configured to carry out authentication of a total point data having a total point data body which contains a total number of points of the portable terminal and a date information for identifying point granted dates, and a total point authentication data to be used in authenticating the total point data body;
an updated point data generation unit configured to generate an updated point data having an updated point data body which contains information on the total number of points of the portable terminal as updated according to transaction contents at a point issuing organization and updated date information, and an updated point authentication data to be used in authenticating the updated point data body; and
an updated point transmission unit configured to transmit the updated point data to a point management server.

6. The point generation device of claim 5, wherein the total point data authentication unit authenticates the total point data body which contains a total number of points of the portable terminal, an identification information of at least one of the point issuing organization and a point issuing person that issued points, an identification information of at least one of the portable terminal and a user of the portable terminal, the date information on issued dates of points, and an information for identifying that it is the total point data;
the total point data authentication unit authenticates the total point authentication data which contains a digital signature of at least one of the point issuing organization and the point issuing person with respect to the total point data body, and a public key certificate of at least one of the point issuing organization and the point issuing person which is certified by a prescribed certificate authority;
the updated point data generation unit generates the updated point data body which contains an updated total number of points, an identification information of at least one of the point issuing organization and the point issuing person, an identification information of at least one of the portable terminal and the user of the portable terminal, and an information for identifying that it is the updated point data; and
the updated point data generation unit generates the updated point authentication data which contains a digital signature of at least one of the point issuing organization and the point issuing person with respect to the updated point data body, and a public key certificate of at least one of the point issuing organization and the point issuing person which is certified by the prescribed certificate authority.

7. The point generation device of claim 5, further comprising:
a device authentication unit having at least one of a device authentication function for checking a reliability of the portable terminal of each model number, and a user authentication function for checking a reliability of a user of the portable terminal.

8. The point generation device of claim 5, further comprising:
a revocation list registration unit having at least one of a terminal revocation list for registering information regarding specific portable terminals which committed illegal acts in past, and a device revocation list for registering information regarding model numbers of portable terminals which have problems in terms of security; and
a revocation judgement unit configured to prohibit generation or consumption of point data when at least one of the portable terminal and a model number of the portable terminal is registered in the revocation list registration unit.

9. A portable terminal for carrying out authentication and consumption of point data generated by a point generation device, the portable terminal comprising:
a granted point data authentication unit configured to carry out authentication of a granted point data having a granted point data body which contains information on a number of points granted from the point generation device, and a granted point authentication data to be used in authenticating the granted point data body; and
a consuming point data generation unit configured to generate a consuming point data having a consuming point data body which contains information on a number of points to be consumed by the portable terminal, and a consuming point authentication data to be used in authenticating the consuming point data body.

10. The portable terminal of claim 9, wherein the granted point data authentication unit authenticates the granted point data body which contains a number of points granted to the portable terminal, an identification information of at least one of a point issuing organization and a point issuing person that grants points, an identification information of at least one of the portable terminal and a user of the portable terminal, and an information for identifying that it is the granted point data;
the granted point data authentication unit authenticates the granted point authentication data which contains a digital signature of at least one of the point issuing organization and the point issuing person with respect to the granted point data body, and a public key certificate of at least one of the point issuing organization and the point issuing person which is certified by a prescribed certificate authority;
the consuming point data generation unit generates the consuming point data body which contains a number of points to be consumed by the portable terminal, an identification information of at least one of the point issuing organization and the point issuing person, an identification information of at least one of the portable terminal and the user of the portable terminal, and an information for identifying that it is the consuming point data; and
the consuming point data generation unit generates the consuming point authentication data which contains a digital signature of at least one of the portable terminal and the user of the portable terminal with respect to the consuming point data body, and a public key certificate of at least one of the portable terminal and the user of the portable terminal which is certified by the prescribed certificate authority.

11. The portable terminal of claim 9, further comprising:
a device authentication unit having at least one of a device authentication function for checking a reliability of the point generation device of each model number, and an issuing organization or issuing person authentication function for checking a reliability of at least one of a point issuing organization or a point issuing person that grants points.

12. A portable terminal for carrying out authentication and consumption of point data generated by the point generation device, the portable terminal comprising:
a total point data storage unit configured to store a total point data having a total point data body which contains a total number of points of the portable terminal and a date information for identifying point granted dates, and a total point authentication data to be used in authenticating the total point data body; and
a data transmission control unit configured to transmit at least a part of the total point data stored in the total point data storage unit for a purpose of point transaction, and to store an updated point data having an updated point data body which contains information on an updated total number of points of the portable terminal and updated date information, and an updated point authentication data to be used in authenticating the updated point data body, into the total point data storage unit.

13. The portable terminal of claim 12, wherein the total point data stores unit stores the total point data body which contains a total number of points of the portable terminal, an identification information of at least one of a point issuing organization and a point issuing person that issued points, an identification information of at least one of the portable terminal and a user of the portable terminal, the date information on issued dates of points, and an information for identifying that it is the total point data;
the total point data storage unit stores the total point authentication data which contains a digital signature of at least one of the point issuing organization and the point issuing person with respect to the total point data body, and a public key certificate of at least one of the point issuing organization and the point issuing person which is certified by a prescribed certificate authority;
the data transmission control unit stores the updated point data body which contains an updated total number of points, an identification information of at least one of the point issuing organization and the point issuing person, an identification information of at least one of the portable terminal and the user of the portable terminal, and an information for identifying that it is the updated point data; and
the data transmission control unit stores the updated point authentication data which contains a digital signature of at least one of the point issuing organization and the point issuing person with respect to the updated point data body, and a public key certificate of at least one of the point issuing organization and the point issuing person which is certified by the prescribed certificate authority.

14. The portable terminal of claim 12, further comprising:
a device authentication unit having at least one of a device authentication function for checking a reliability of the point generation device of each model number, and an issuing organization or issuing person authentication function for checking a reliability of at least one of a point issuing organization or a point issuing person that grants points.

15. A point management system, comprising:
a point generation device for carrying out generation and authentication of point data;
a portable terminal for carrying out authentication and consumption of the point data generated by the point generation device; and
a point management server for carrying out management of the point data;
wherein the point generation device has:
a granted point data generation unit configured to generate a granted point data having a granted point data body which contains information on a number of points granted to the portable terminal, and a granted point authentication data to be used in authenticating the granted point data body;
a consuming point data authentication unit configured to carry out authentication of a consuming point data having a consuming point data body which contains information on a number of points to be consumed by the portable terminal, and a consuming point authentication data to be used in authenticating the consuming point data body; and
a point data transmission unit configured to transmit the granted point data to the portable terminal and the point management server, and transmit the consuming point data to the point management server; and
the portable terminal has:
a granted point data authentication unit configured to carry out authentication of the granted point data having the granted point data body which contains information on a number of points granted from the point generation device, and the granted point authentication data to be used in authenticating the granted point data body; and
a consuming point data generation unit configured to generate the consuming point data having the consuming point data body which contains information on a number of points to be consumed by the portable terminal, and the consuming point authentication data to be used in authenticating the consuming point data body.

16. The point management system of claim 15, wherein the point management server has:
a point collecting unit configured to collect the point data of the portable terminal that are generated by the point generation device within each prescribed period of time;
a consistency checking unit configured to check consistency among the point data collected by the point collecting unit; and
an illegal person discovery unit configured to discover an illegal person according to a check result obtained by the consistency checking unit.

17. A point management system, comprising:
a point generation device for carrying out generation and authentication of point data;
a portable terminal for carrying out authentication and consumption of the point data generated by the point generation device; and
a point management server for carrying out management of the point data;
wherein the point generation device has:
a total point data authentication unit configured to carry out authentication of a total point data having a total point data body which contains a total number of points of the portable terminal and a date information for identifying point granted dates, and a total point authentication data to be used in authenticating the total point data body;
an updated point data generation unit configured to generate an updated point data having an updated point data body which contains information on the total number of points of the portable terminal as updated according to transaction contents at a point issuing organization and updated date information, and an updated point authentication data to be used in authenticating the updated point data body; and
an updated point transmission unit configured to transmit the updated point data to a point management server; and
the portable terminal has:
a total point data storage unit configured to store the total point data having the total point data body which contains a total number of points of the portable terminal and the date information for identifying point granted dates, and the total point authentication data to be used in authenticating the total point data body; and
a data transmission control unit configured to transmit at least a part of the total point data stored in the total point data storage unit for a purpose of point transaction, and to store the updated point data having the updated point data body which contains information on an updated total number of points of the portable terminal and the updated date information, and the updated point authentication data to be used in authenticating the updated point data body, into the total point data storage unit.

18. The point management system of claim 17, wherein the point management server has:
a point collecting unit configured to collect the total point data of the portable terminal that are generated by the point generation device within each prescribed period of time;
a consistency checking unit configured to check consistency among the total point data collected by the point collecting unit; and
an illegal person discovery unit configured to discover an illegal person according to a check result obtained by the consistency checking unit.
